(19) United States
(12) Patent Application Publication
(10) Pub. No.: US 2014/0221499 A1
(43) Pub. Date: Aug. 7, 2014

(54) NOVEL RODENT CONTROL AGENTS AND USES THEREOF

(71) Applicants: Stephen D. Liberles, Wellesley, MA (US); David M. Ferrero, New York, NY (US)

(72) Inventors: Stephen D. Liberles, Wellesley, MA (US); David M. Ferrero, New York, NY (US)

(73) Assignee: PRESIDENT AND FELLOWS OF HARVARD COLLEGE, Cambridge, MA (US)

(21) Appl. No.: 14/126,652

(22) PCT Filed: Apr. 26, 2012
(86) PCT No.: PCT/US2012/035150

§ 371 Date: Apr. 8, 2014

Related U.S. Application Data
(60) Provisional application No. 61/497,654, filed on Jun. 16, 2011.

(51) Int. Cl. A01N 33/00

(52) U.S. Cl. CPC A01N 33/00
USPC 514/654

(57) ABSTRACT

Provided herein is method for controlling a rodent. The method comprises contacting the rodent with a compound which is a ligand for an olfactory trace amine associated receptor (TAAR) or a composition comprising such a molecule. The compound can be a biogenic amine.

### RELATED APPLICATIONS

This application claims benefit under 35 U.S.C. §119(e) of the U.S. Provisional Application No. 61/497,654, filed Jun. 16, 2011 content of which is incorporated herein by reference in its entirety.

### GOVERNMENT SUPPORT

This invention was made with U.S. Government support under Grant Number: R01DC010155 awarded by the National Institute On Deafness And Other Communicative Disorders. The Government has certain rights in the invention.

### BACKGROUND

Predator-prey relationships provide a classic paradigm for understanding the molecular basis of complex behavior (1). Predator-derived visual, auditory, and olfactory cues induce hard-wired defensive responses in prey that are sculpted by strong evolutionary pressure and are critical for survival. For example, odors from felines, canines, and other predators elicit innate reactions in rodents, including stereotyped avoidance behaviors and stimulation of the hypothalamic-pituitary-adrenal axis that coordinates sympathetic stress responses (1). Aversive reactions to odors can function in reverse as well, as skunk thiols facilitate prey escape by repelling predator species (2).

Predator odors contain a class of ecological chemosignals termed kairomones, cues transmitted between species that benefit the detecting organism. Predator odor-derived kairomones that elicit defensive responses in rodents are largely unknown, and can be found in fur, dander, saliva, urine, or feces of divergent predator species. One volatile chemical produced by foxes, 2,5-dihydro-2,4,5-trimethylthiazole (TMT), and two nonvolatile lipocalins produced by cats and rats elicit fear-like or aversive behavior in mice, enabling remote or contact-based detection of predator cues (3-5). Each of these chemicals is not broadly produced by predators, raising the possibility that rodents detect a multitude of species-specific predator signals, each of which triggers a hard-wired defensive response. Alternatively, or in addition, prey species could detect predators through common metabolites derived from shared metabolic pathways or a carnivorous diet (6). While common predator metabolites could in principle provide a generalizable mechanism for rodents to avoid many predators, even those not previously encountered during the history of an individual or species, no such kairomones have been identified.

Odors from carnivores elicit stereotyped fear and avoidance responses in rodents, although sensory mechanisms involved are largely unknown. Predator odors are thought to activate sensory receptors in both the olfactory epithelium and vomeronasal organ of rodents (1, 4, 5), but particular rodent sensory receptors that selectively respond to predator odors have not been identified. Some crude predator odor sources, such as cat fur and saliva, activate neural circuitry associated with the accessory olfactory system, and are thus likely detected by vomeronasal receptors (1, 7). Furthermore, predator-derived lipocalins activate mouse vomeronasal sensory neurons, and do not trigger defensive behavior in animals lacking TrpC2, a key signal transduction channel in vomeronasal neurons (5). Other predator odors, however, elicit powerful aversion responses through the main olfactory system. Mice lacking sensory receptors in a broad dorsal domain of the main olfactory epithelium do not avoid TMT or leopard urine, and instead ignore or are attracted to them (4). Thus, multiple olfactory subsystems detect different predator odors and enact appropriate defensive responses. Olfactory receptors that selectively respond to predator odors, whether expressed in the main olfactory epithelium, vomeronasal organ, or other olfactory substructure, could provide a strong evolutionary advantage for rodents.

### SUMMARY

One aspect of the invention relates to a method for controlling a rodent, comprising contacting a rodent with a composition comprising a compound of the invention. In some embodiment, controlling the rodent comprises repelling the rodent. In some embodiments, the composition comprises a compound which is a ligand for an olfactory trace amine associated receptor (TAAR). A TAAR can be selected from TAAR2, TAAR3, TAAR4, TAAR5, TAAR6, TAAR7a, TAAR7b, TAAR7d, TAAR7e, TAAR7f, TAAR8a, TAAR8b, TAAR8c, TAAR9 in mouse, as well as paralogs and orthologs in other rodents.

In some embodiments of this and other aspects of described herein, the TAAR ligand is a biogenic amine.

In some embodiments of this and other aspects described herein, the TAAR ligand is selected from the group consisting of 2-phenylethylamine, N,N-dimethyl-2-phenylethylamine, N,N-dimethylcyclohexylamine, 5-methoxy-N,N-dimethyltryptamine, trimethylamine, isoamylamine, cyclohexylamine, 2-methylbutylamine, dimethylethylamine, N-methylpiperidine, and analogues and derivatives thereof.

In some embodiments of this and other aspects described herein, the composition comprises two or more (e.g., two, three, four, five, six, seven, eight, nine, ten or more) different TAAR ligands.

Another aspect of the invention relates to a delivery device comprising at least one compound of the invention.

Yet another aspect of the invention relates to the discovery of a chemical compound that activates an olfactory receptor in a rodent and produces an innate behavioral response. In one embodiment, this predator cue was isolated from bobcat urine and identified it to be a biogenic amine. In one embodiment a biogenic amine is an amine produced by a life process, such as constituents, or secretions, of plants or animals. In one embodiment, the compound is 2-phenylethylamine. In another embodiment, the compound is an analogue or derivative of 2-phenylethylamine, including but not limited to N,N-dimethyl-2-phenylethylamine. In some embodiments, the compound is N,N-dimethylcyclohexylamine. In further embodiments, the compound is 5-methoxy-N,N-dimethyltryptamine. In another embodiment, the compound is an activator of a related olfactory signaling mechanisms, including but not limited to trimethylamine, isoamylamine, cyclohexylamine, 2-methylbutylamine, dimethylethylamine, and N-methylpiperidine. In another embodiment, the aversion is to a mixture of chemicals that includes 2-phenylethylamine. In some embodiments, the compound is a ligand for an olfactory trace amine associated receptors (TAARs). In another embodiment, the aversion is to a mixture of chemicals that includes at least one TAAR ligand.

### BRIEF DESCRIPTION OF THE DRAWINGS

FIG. 1 illustrates that TAAR4 detects predator odors. (A) HEK293 cells were transfected with TAAR4 and reporter plasmids, incubated with urine extracts of species indicated, and assayed for reporter activity (triplicates±SD). TAAR4 was activated by urine extracts (10-fold dilution) of two rodent predators, bobcat and mountain lion, but not of mouse, rat, or human. No responses were observed to animals odors in control cells transfected with reporter plasmid alone. TAAR4 was expressed as a fusion protein with an N-terminal sequence of bovine rhodopsin, which provided enhanced signal (24). (B) Rat TAAR9, rat TAAR8c, and mouse TAAR7f detected urine of multiple species, including mouse, rat, and human. Urine (diluted 300- or 100-fold) or urine extracts (diluted 30-, 10-, or 3-fold) of species indicated were tested (triplicates±s.d.).

FIG. 2 illustrates that 2-phenylethylamine is a predator odor in bobcat urine. (A) Bobcat urine was fractionated by silica gel chromatography, and fractions analyzed for the presence of TAAR4 activator with the reporter gene assay (triplicates±SD). (B) An ion with the same mass and fragmentation pattern of 2-phenylethylamine was observed in a bobcat urine active fraction. (C) Commercial 2-phenylethylamine, but not benzylamine, activated TAAR4 (triplicates±SD). (D) 2-phenylethylamine (10 μM) activates TAAR4 but does not similarly activate other olfactory TAARs with identified agonists.

FIG. 3 illustrates that 2-phenylethylamine is a component common to many carnivore odors. (A) LC/MS analysis of bobcat urine extracts, graphed as number of ion counts with m/z⁻-122 over time, identified a single peak with identical retention time to 2-phenylethylamine. (B) 2-phenylethylamine (PEA) levels were quantified in multiple urine samples (#) from 38 species and 6 orders of mammals, as indicated. Samples were either purchased (p), provided by a zoo (z), or collected (c). (C) Average urinary 2-phenylethylamine levels were >50- to 500-fold higher in carnivores than in other mammalian orders.

FIG. 4 illustrates that 2-phenylethylamine activates rodent olfactory sensory neurons. (A) Representative cytosolic calcium responses of individual olfactory sensory neurons in acute tissue slices. Fluo-4-loaded neurons (defined by contours indicated) were exposed to 2-phenylethylamine and elevated KCl (40 mM). Background-subtracted images of reporter dye intensity are coded in pseudocolors (rainbow spectrum). (B) Percentage of dorsal (n=804) and ventral (n=520) olfactory sensory neurons activated by 2-phenylethylamine at concentrations indicated. (C) Percentage of dorsal olfactory sensory neurons (n=1747) activated by 2-phenylethylamine at various concentrations. (D) Representative traces of integrated Fluo-4 fluorescence over time in individual dorsal olfactory sensory neurons exposed to test stimuli: 2-phenylethylamine (100 pM), lion urine (FIG. 18, specimen 5, 1:10,000), giraffe urine (FIG. 18, specimen 1, 1:10,000), benzylamine (100 pM), and KCl (40 mM).

FIG. 5 illustrates that 2-phenylethylamine elicits an innate avoidance response in rodents. (A) A cartoon depiction of the experimental arena and ligand structures are shown. Movements of rats in response to test stimuli were recorded automatically using infrared detectors. (B) 3D surface plots depict the percentage of time twelve rats are in regions of a square arena following exposure to test stimuli (1 ml water or lion urine, 5 μl PEA or BA) in the corner indicated (circle). Similar responses were observed when PEA and BA were diluted in 1 ml water. Color scaling from red to blue indicates increased time spent in a particular region. (C) Mean percentage of time rats were located in the quadrant containing test stimuli was measured (12 animals, ±SEM, **p<0.01). (D) Mean percentage of time rats occupied the quadrant containing 10% lion urine and 2-phenylethylamine (0, 0.4, 4, and 40 μmol) diluted in water or giraffe urine (1 ml), (12 animals, ±SEM, **p<0.01). (E) Corticosterone levels in rat plasma determined by radioimmunoassay following exposure to odors indicated (1 ml water, 2% TMT, 10% PEA, or 10% BA, 30 min, 8-20 animals, ±SEM, *p<0.05). (F) Responses of wild type or TrpC2⁴⁻ mice to odors indicated (aerosolized from 10 μmol) were measured as a change in percentage occupancy of an odor compartment during a 3 minute stimulus presentation (n=5-7, ±SEM, *p<0.05).

FIG. 6 illustrates that 2-phenylethylamine is a key aversive component of a predator odor blend. (A,B) Quantitative LC/MS analysis of lion urine (10%) before and after addition of MAO-B was used to measure PEA concentration. (C) Mean percentage of time rats were located in odor quadrants containing water, 1%, or 10% lion urine, “PEA-depleted lion urine”, or “PEA-respiked lion urine” (eleven animals, ±SEM, **p<0.01).

FIG. 7 illustrates thirteen TAARs detect volatile amines. HEK293 cells were transfected with TAAR and reporter plasmids, incubated with ligands (10 μM), and assayed for reporter activity (triplicates±s.d.). Test conditions were 1 no ligand, 2 isoamylamine, 3 2-phenylethylamine, 4 trimethylamine, 5 N,N-dimethylbutylamine, 6 N,N-dimethyl-2-phenylethylamine, 7 5-methoxy-N,N-dimethyltryptamine, 8 N,N-dimethyloctylamine, 9 N-methylpiperidine, or 10 N,N-dimethylcyclohexylamine. Twelve TAARs indicated and rTAAR3 (Supplementary FIG. 1) responded to at least one ligand shown, but no responses were observed in control cells transfected with reporter plasmid alone.

FIGS. 8A-8C illustrate functional evolution of the TAAR family. (a) TAAR phylogenetic tree constructed by Bayesian analysis of all TAAR nucleotide sequences in the mouse, human, and rat genomes. TAARs cluster into two groups, which exhibit distinct binding preferences for primary or tertiary amines. All tree nodes have a posterior probability above 0.9, except * (0.87), and [symbol] (0.86). (b) Activity of ligands 6 and 10. Four TAARs with sequences shown above the line (mTAAR7b, rTAAR7b, rTAAR7d, mTAAR7f) respond to ligand 10 but not ligand 6, whereas two TAARs with sequences shown below the line (mTAAR7e, rTAAR7h) respond to ligand 6 but not ligand 10. (c) Alignment of the amino acid sequences of six TAAR7s with identified ligands Residues that vary in 2 or more receptors are colored in green, mutated positions (see FIG. 3) are colored in red, and TM segments are shown in blue.

FIG. 9 illustrates altering TAAR responses by mutation of an odor selectivity filter. Sequences of mTAAR7e were swapped into mTAAR7f and vice versa by exchanging residues 132^{3.37} and 133^{3.38} of mTAAR7e (‘mTAAR7e-YC’) and mTAAR7f (‘mTAAR7f-SS’). Odor responses of these mutant receptors are shown using the cellular reporter gene assay for ligands 6, 7, and 10 at concentrations indicated (triplicates±sem).

FIG. 10 illustrates homology modeling of TAAR7e and TAAR7f provides a molecular basis for selective odor recognition. Predicted structures (cyan) of mTAAR7e (a), and mTAAR7f (b) bound to ligand 6 (yellow). GPCR transmembrane helices are numbered from TM I through TM VII and side chains of key residues that line the ligand binding site are displayed. Hydrogen bonds are shown as dotted cyan lines. Inserts represent a magnified view of ligand 6 interacting with residue 132^{3.37} of mTAAR7e and mTAAR7f. Van der waals radii are shown with a space-filling model, and predict a steric clash of ligand 6 with residue Tyr132^{3.37} but not Ser132^{3.37}.

FIG. 11 illustrates the dose-dependent responses of TAARs to amines. HEK293 cells were cotransfected with plasmids encoding CRE-SEAP and rTAARs (a) or mTAARs (b), incubated with concentrations of ligands indicated, and assayed for reporter activity (triplicates±s.d.). EC₅₀ values (±s.e.m, bottom right) were calculated using SigmaPlot (Systat Software) and a 4-parameter Hill equation. EC₅₀ values for receptor-ligand interactions that did not reach saturation are not determined.

FIG. 12 shows homology modeling of mTAAR7e and mTAAR7f bound to 5-methoxy-N,N-dimethyltryptamine (7). Predicted structures (cyan) of mTAAR7e (a) and mTAAR7f (b) bound to 7 (yellow). GPCR transmembrane helices are numbered TM I to VII and side chains of key residues that line the ligand binding site are displayed. Hydrogen bonds are shown as dotted cyan lines. Inserts represent a magnified view of 7 interacting with residue 132^{3.37} of mTAAR7e and mTAAR7f. Van der Waals radii are shown with a space-filling model, and predict a steric clash of 7 with residue Tyr132^{3.37} of mTAAR7f but not Ser132^{3.37} of mTAAR7e.

FIG. 13 shows homology models of mTAAR7e and mTAAR7f bound to N,N-dimethylphenylethylamine (6) and 5-methoxy-N,N-dimethyltryptamine (7), shown in stereo.

FIG. 14 illustrates the responses of TAAR9, TAAR8c, and TAAR7f to carnivore urines. HEK293 cells were transfected with TAAR and reporter plasmids, incubated with urine extracts indicated, and assayed for reporter activity (triplicates±SD). Rat TAAR8c and rat TAAR9 detected urine extracts of carnivores (jaguar and mountain lion) and non-carnivores (mouse, rat, human) with similar sensitivity. Mouse TAAR7f weakly detected jaguar urine. No responses were observed to animals odors in control cells transfected with reporter plasmid alone.

FIGS. 15A-E show that TAAR4 has a narrow chemoreceptive field. (A, B) The names and structures of phenylalanine metabolites and other chemicals tested in TAAR4 functional assays. (C) TAAR4 detects 2-phenylethylamine but not related chemicals or other phenylalanine metabolites with similar sensitivity. HEK293 cells were transfected with TAAR4 plasmid and CRE-SEAP, incubated with ligands indicated (10 μM), and assayed for reporter activity (triplicates±SD). TAAR4 was expressed as a fusion protein with an N-terminal sequence of bovine rhodopsin, which provided enhanced signal. (D,E) 3-phenylpropylamine activates TAAR4 at high concentrations, while 2-phenylethanol did not activate TAAR4 at any concentration tested.

FIG. 16 illustrates that TAAR3 detects both 2-phenylethylamine and benzylamine. Reporter gene assays were performed on HEK293 cells transfected with mouse TAAR3 and CRE-SEAP. TAAR3 detects numerous primary amines including isoamylamine as a preferred ligand, 2-phenylethylamine (EC₅₀=˜100 μM), and benzylamine (EC₅₀=˜200 μM). TAAR3 detects 2-phenylethylamine with 30-fold reduced sensitivity compared to TAAR4 and similarly detects benzylamine, which does not elicit avoidance behavior.

FIGS. 17A-B illustrate the quantitative analysis of 2-phenylethylamine by LC/MS. (A) LC/MS was performed on solutions containing various concentrations of 2-phenyethylamine, and the number of ion counts with m/z=122 graphed versus retention time. Analysis of 2-phenylethylamine standards yielded single peaks of consistent retention time whose integrated areas were correlated with concentration. (B) Plotting integrated 2-phenylethylamine peak area versus 2-phenylethylamine concentration enabled calculation of 2-phenylethylamine concentration in unknown samples based on linear regression analysis of peak area using the sum of least square method (Excel, Microsoft).

FIG. 18 illustrates 2-phenylethylamine (PEA) levels in each of 123 individual urine specimens from 38 mammalian species used for FIG. 16. The sources of samples are shown, and zoo specimens from the same species either originated from different animals, or in some cases from the same animals collected on different days. Purchased specimens from the same species and source originate from different lots. Mouse and rat samples were collected overnight using a metabolic cage. One cat sample was collected overnight using non-absorbent litter (NoSorb Beads, Catco).

FIGS. 19A-B illustrate the expression patterns of TAARs in olfactory epithelium. (A) Expression of Taar4 in coronal sections of mouse olfactory epithelium is visualized by fluorescent in situ hybridization as previously described (1). Neurons expressing TAAR4 are dispersed in a dorsal zone of the olfactory epithelium. (B) The location of other TAAR-expressing neurons along the dorsal-ventral axis is summarized. All TAARs are expressed dorsally, except for TAAR6 and at least one TAAR7 subfamily member.

### DETAILED DESCRIPTION OF EXEMPLARY EMBODIMENTS

In one aspect, provided herein is a method for controlling a rodent. In some embodiments, the method comprises contacting a rodent with a compound which is a ligand for an olfactory trace amine associated receptor (TAAR) or a composition comprising such a compound.

As used herein, the term “ligand” refers both to a molecule capable of binding to a receptor and to a portion of such a molecule, if that portion of a molecule is capable of binding to a receptor. A ligand can be an activator or inhibitor of the receptor. As used herein, the term, “inhibitor” refers to a ligand which acts to reduce or inhibit activity of the receptor, e.g. a TAAR. As used herein, the term “activator” refers to a ligand which acts to increase activity of the receptor, e.g. a TAAR.

Without limitations, the TAAR can be from any rodent. For example, a TAAR can be a mouse TAAR selected from the group consisting of TAAR2, TAAR3, TAAR4, TAAR5, TAAR6, TAAR7a, TAAR7b, TAAR7d, TAAR7e, TAAR7f, TAAR8a, TAAR8b, TAAR8c, TAAR9, and homologs thereof.

As used herein, the teem “homolog” when used in reference to amino acid sequence or a protein or a polypeptide refers to a degree of sequence identity to a given sequence, or to a degree of similarity between conserved regions, or to a degree of similarity between three-dimensional structures or to a degree of similarity between the active site, or to a degree of similarity between the mechanism of action, or to a degree of similarity between functions. In some embodiments, a homolog has a greater than 20% sequence identity to a given sequence. In some embodiments, a homolog has a greater than 40% sequence identity to a given sequence. In some embodiments, a homolog has a greater than 60% sequence identity to a given sequence. In some embodiments, a homolog has a greater than 70% sequence identity to a given sequence. In some embodiments, a homolog has a greater than 90% sequence identity to a given sequence. In some embodiments, a homolog has a greater than 95% sequence identity to a given sequence. In some embodiments, homology is determined by comparing internal conserved sequences to a given sequence. In some embodiments, homology is determined by comparing designated conserved functional regions. In some embodiments, homology is determined by comparing designated conserved motif regions.

As used herein, the term “homolog” includes paralogs and orthologs. As used herein, the term “paralog” refers to a polypeptide or protein obtained from a given species that has homology to a distinct polypeptide or protein from that same species. As used herein, the term “ortholog” refers to a polypeptide or protein obtained from one species that has homology to an analogous polypeptide or protein from a different species. Accordingly, in some embodiments, a TAAR can be a parlog or ortholog of a mouse TAAR.

Aspects of the inventions are based on inventors' discovery that biogenic amines can be ligands for TAAR. Accordingly, in some embodiments of this and other aspects of described herein, the TAAR ligand is a biogenic amine.

In some embodiments of this and other aspects described herein, the TAAR ligand is an amine, e.g., a mono-, di- or trisubstituted amine. Without limitations, each substitutent on the amine can be selected independently a linear or branched alkyl, a linear or branched alkenyl, a linear or branched alkynyl, a cyclyl, a heterocyclyl, an aryl, or a heteroaryl. Without limitations, each of the alkyl, alkenyl, alkynyl, cyclyl, hetereocylcyl, aryl, and heteroaryl can be optionally substituted with 1 or more (e.g., one, two, three, four, five, six or more) substituents. In addition an alkyl, alenyl or alkynyl can comprise one or more of O, S, or NH in its backbone

In some embodiments of this and other aspects described herein, the TAAR ligand is selected from the group consisting of 2-phenylethylamine, N,N-dimethyl-2-phenylethylamine, N,N-dimethylcyclohexylamine, 5-methoxy-N,N-dimethyltryptamine, trimethylamine, isoamylamine, cyclohexylamine, 2-methylbutylamine, dimethylethylamine, N-methylpiperidine, and analogues and derivatives thereof.

Quantitative HPLC analysis across 38 mammalian species indicates enriched 2-phenylethylamine production by numerous carnivores, with some producing >3,000 fold more than herbivores examined. Calcium imaging of neuronal responses in mouse olfactory tissue slices identified dispersed carnivore odor-selective sensory neurons that also responded to 2-phenylethylamine. Two prey species, rat and mouse, avoid a 2-phenylethylamine odor source, and loss-of-function studies involving enzymatic depletion of 2-phenylethylamine from a carnivore odor indicate it can be a component for full avoidance behavior. Thus, rodent olfactory sensory neurons and chemosensory receptors have the capacity for recognizing interspecies odors. One such cue, carnivore-derived 2-phenylethylamine, is a key component of a predator odor blend that triggers hardwired aversion circuits in the rodent brain. These data show how a single, volatile chemical detected in the environment can drive an elaborate danger-associated behavioral response in mammals.

2-phenylethylamine was identified to be a natural product with enriched production by numerous carnivores. This chemical activates HEK293 cells expressing a mouse olfactory receptor and elicits calcium responses in mouse olfactory sensory neurons. 2-phenylethylamine also evokes physiological and behavioral responses in two prey species, as it repels mice and rats, and induces an associated corticosterone surge in rats. Innate avoidance responses were maintained in mice lacking TrpC2, indicating that vomeronasal signaling is not required. Furthermore, depletion of 2-phenylethylamine from one carnivore odor, lion urine, alters rat response behavior. Together, these data indicate that 2-phenylethylamine is a predator odor-derived kairomone detected and avoided by prey. Understanding the molecular basis of predator odor recognition by the rodent olfactory system provides tools to study neural circuitry associated with innate behavior.

Based on data presented, 2-phenylethylamine (1) is a component general to many carnivore odors, (2) activates a rodent olfactory receptor in heterologous cells and multiple populations of olfactory sensory neurons in tissue slices, (3) elicits innate avoidance behavior in rats and mice, and (4) is a required component of a lion odor blend that evokes aversion responses. Together, these data indicate that 2-phenylethylamine is a predator odor-derived kairomone detected and avoided by prey species.

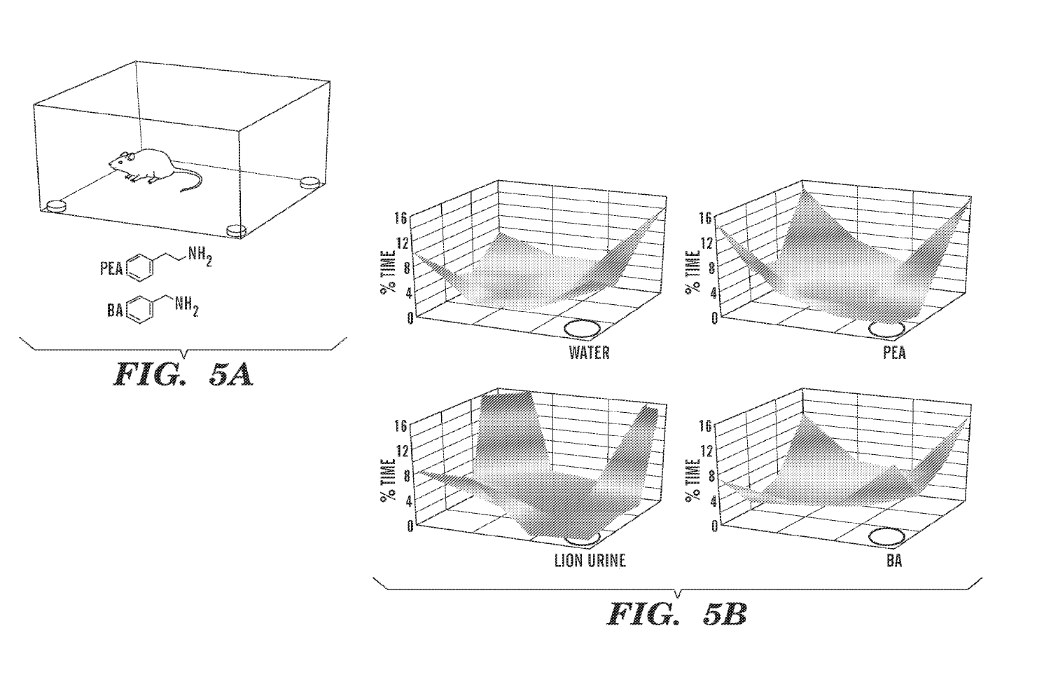

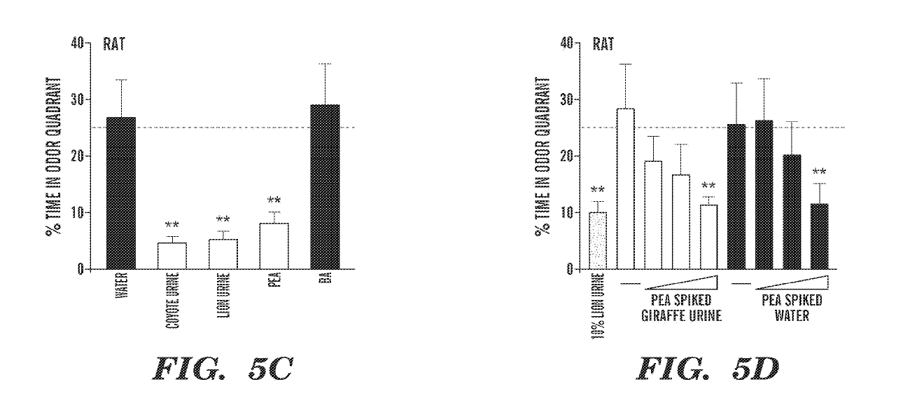

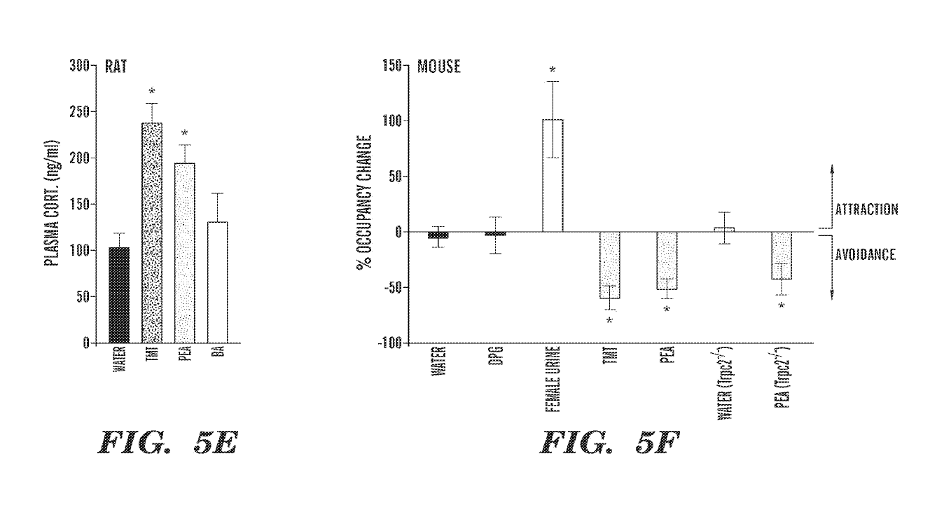

Based on the inventors quantitative analysis of 2-phenylethylamine-evoked aversion (FIG. 5D), it is likely that behavioral responses to carnivore urine involve cooperative recognition of multiple cues. In one embodiment, the aversion is to 2-phenylethylamine. In one embodiment, the aversion is to an analogue or derivative of 2-phenylethylamine. In another embodiment, the aversion is to a mixture of chemicals that includes 2-phenylethylamine. This is consistent with neuronal imaging results indicating 2-phenylethylamine to be a major, but not exclusive, component of predator urine recognized by the olfactory system. In analogy, some aggression-promoting mouse pheromones elicit innate responses when presented in the context of an odor blend (19). In one embodiment, 2-phenylethylamine contributes to the aversive quality of a carnivore odor, as lion urine depleted of this chemical does not elicit a significant avoidance response.

The increased production of 2-phenylethylamine can reflect metabolic or dietary differences in the carnivore order. 2-phenylethylamine is a metabolite of phenylalanine, an essential amino acid found in dietary protein (20). One attractive model to explain the data of the invention is that elevated levels of dietary protein in meat-eating species directly lead to enhanced 2-phenylethylamine levels in urine. However, manipulation of protein levels in the diet of mouse and rat had no effect on lower levels of 2-phenylethylamine production in these species. This result does not exclude that manipulation of protein levels in carnivore species could affect 2-phenylethylamine production. Alternatively, enhanced 2-phenylethylamine production in carnivores could be explained by order-particular differences in phenylalanine usage and metabolism rather than on levels consumed in diet. Last, it is also possible that 2-phenylethylamine is released by some carnivores as a scent mark involved in social behavior.

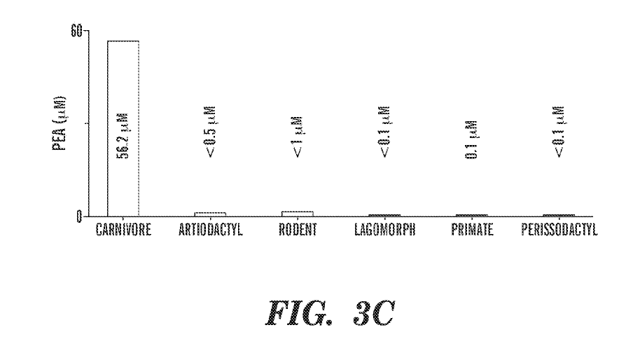

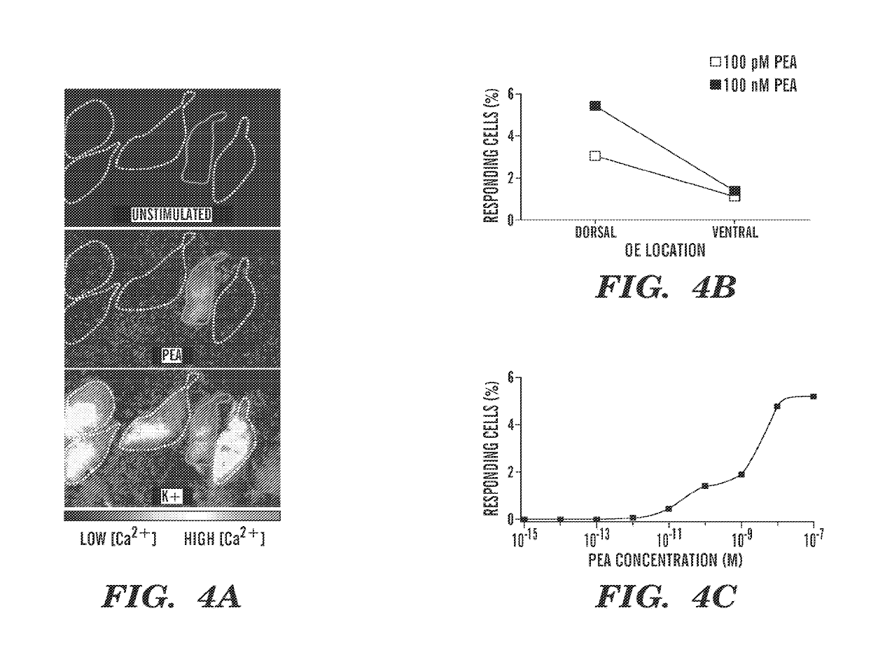

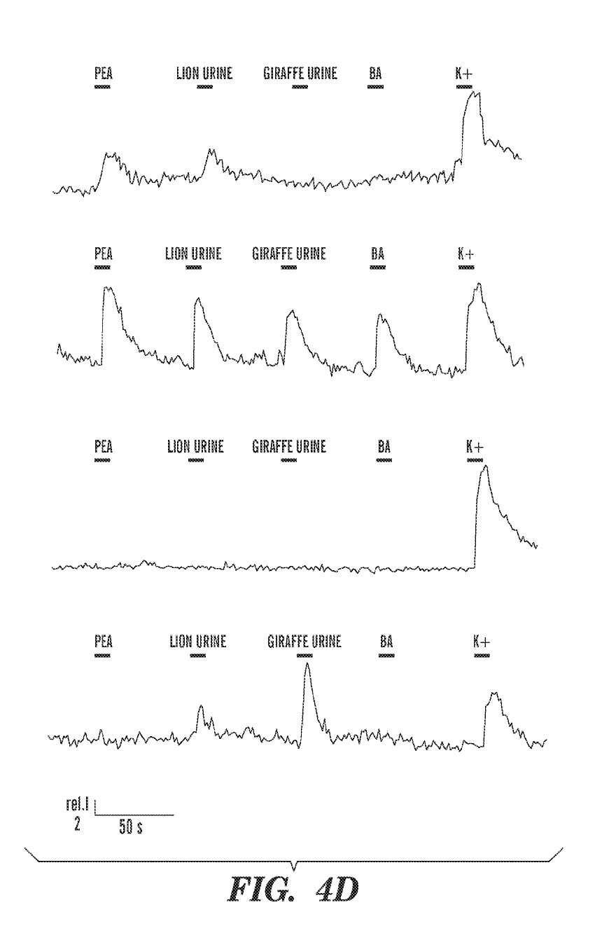

Olfactory receptors that activate hard-wired neural circuits underlying 2-phenylethylamine avoidance are unknown. TAAR4 is an excellent candidate to function as a kairomone receptor, although based on population imaging, other olfactory receptors contribute to 2-phenylethylamine recognition. A role for vomeronasal receptors is unlikely since TrpC2 knockout mice still avoid 2-phenylethylamine. Consistent with this, avoidance responses to one carnivore urine are ablated in mice lacking function in dorsal olfactory epithelium (4), indicating that this carnivore urine response is distinct from some other predator odor responses (5, 7) in requiring main olfactory rather than vomeronasal signaling. Rats actively avoided 2-phenylethylamine but not benzylamine, indicating that the innate avoidance we observed was due to activation of an olfactory receptor that can effectively distinguish these highly related amines. Based on calcium imaging data (FIG. 4), —1% of dorsal olfactory sensory neurons are activated by 2-phenylethylamine but not benzylamine. Humans, who lack a TAAR4 ortholog (21), do perceive undiluted 2-phenylethylamine as a mildly unpleasant odor. Rats and mice can detect 2-phenylethylamine with higher sensitivity and selectivity than humans, and perhaps display distinct behavioral responses to this chemical. Results presented here provide a basis for future experiments to probe aversion responses in genetically altered mice lacking TAAR4, or other key genes expressed in peripheral olfactory circuits or central limbic regions of the brain.

Several TAAR ligands are highly aversive odors. Trimethylamine activates TAAR5, and while behavioral responses of mice to this cue are uncharacterized, it is a repugnant odor to humans associated with bacterial contamination, bad breath, and illness (22). Isoamylamine activates TAAR3, and while speculated to be a mouse pheromone that influences reproductive physiology (23), was also shown to be an aversive odor to mice (4). Furthermore, inventors demonstrate that TAAR4 detects a predator odor-enriched cue that repels rodents.

Two distinct models, that are not mutually exclusive, could explain how rodents detect and avoid divergent predator odors. One model involves a myriad of distinct predator odor constituents, each of which is produced with high species and tissue selectivity, and each of which activates distinct olfactory circuits that trigger innate defensive behavior. Species-specific predator odors can be particularly relevant in predator-prey relationships with a long evolutionary history. A second model involves detection of signals commonly produced by many predators, such as 2-phenylethylamine, that provide animals with the ability to avoid novel and dangerous species not previously encountered, an evolutionary benefit.

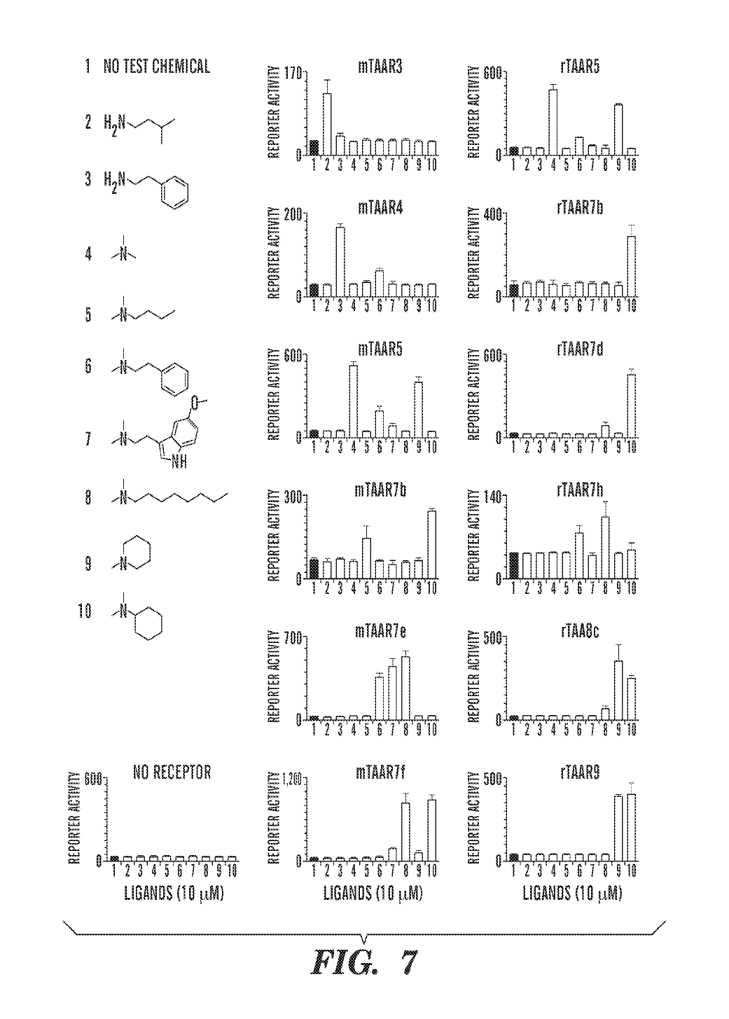

Further, even though ligand recognition properties of TAARs remain poorly understood, as most are “orphan receptors’ without known agonist, the inventors have identified ligands for several rodent TAARs. These receptors are classified into two subfamilies based on phylogeny and binding preference for primary or tertiary amines. Mouse and rat orthologs have similar response profiles, although independent Taar7 gene expansions led to highly related receptors with altered ligand specificities. Using chimeric TAAR7 receptors, the inventors have identified an odor contact site in transmembrane 3 that functions as a selectivity filter. These studies provide new TAAR ligands for nine additional olfactory TAARs that were previously orphan receptors (FIG. 7), including mTAAR7b, mTAAR7e, rTAAR3, rTAAR5, rTAAR7b, rTAAR7d, rTAAR7h, rTAAR8c, and rTAAR9. Each of these nine TAARs was activated by volatile amines, and ligand preferences were generally similar between mouse and rat orthologs. The inventors identified three amines, N,N-dimethylcyclohexylamine 5-methoxy-N,N-dimethyltryptamine, and N,N-dimethylphenylethylamine that activated different TAAR7 paralogs in mouse and rat. In addition, isoamylamine, N,N-dimethyloctylamine, 1-methylpiperidine, N,N-dimethylbutylamine, cyclohexylamine, and methylbutylamine also activated TAARs.

Hence, each one of the identified amines can be used as a rodent deterrent. In one embodiment, the aversion is to N,N-dimethylcyclohexylamine. In some embodiments, the aversion is to 5-methoxy-N,N-dimethyltryptamine. In some embodiments, the aversion is to N,N-dimethylphenylethylamine. In some embodiments, the aversion is to isoamylamine. In some embodiments, the aversion is to N,N-dimethyloctylamine. In some embodiments, the aversion is to N,N-dimethylbutylamine. In some embodiments, the aversion is to 1-methylpiperidine. In some embodiments, the aversion is to cyclohexylamine. In some embodiments, the aversion is to methylbutylamine. In some embodiments, the aversion is to a composition comprising at least one amine of the invention. In some embodiments, the aversion is to a composition comprising at least two amines of the invention. In some embodiments, the aversion is to a composition comprising at least one amine of the invention and at least one ligand for an olfactory TAAR.

Predator-prey relationships provide a powerful paradigm to understand the neuronal basis of instinctive behavior. Avoidance of 2-phenylethylamine illustrates how a single volatile chemical detected in the environment can drive an elaborate behavioral response in mammals through activation of the olfactory system.

One aspect of the invention relates to using a compound of the invention as rodent controlling agent. A controlling agent can initiate or promote a rodent's movement away from a locus. In one embodiment of the invention, the compound is 2-phenylethylamine. In one embodiment, the compound is an analogue or derivative of 2-phenylethylamine. In one embodiment, the compound is N,N-dimethylcyclohexylamine. In one embodiment, the compound is an analogue or derivative of N,N-dimethylcyclohexylamine. In one embodiment, the compound is 5-methoxy-N,N-dimethyltryptamine. In one embodiment, the compound is an analogue or derivative of 5-methoxy-N,N-dimethyltryptamine. In one embodiment, the compound is N,N-dimethylphenylethylamine. In one embodiment, the compound is an analogue or derivative of N,N-dimethylphenylethylamine. In one embodiment of the invention, the compound is isoamylamine. In one embodiment, the compound is an analogue or derivative of isoamylamine. In one embodiment of the invention, the compound is N,N-dimethyloctylamine. In one embodiment, the compound is an analogue or derivative of N,N-dimethyloctylamine. In one embodiment of the invention, the compound is N,N-dimethylbutylamine. In one embodiment, the compound is an analogue or derivative of N,N-dimethylbutylamine. In one embodiment of the invention, the compound is 1-methylpiperidine. In one embodiment, the compound is an analogue or derivative of 1-methylpiperidine. In one embodiment, the compound is cyclohexylamine. In one embodiment, the compound is an analogue or derivative of cyclohexylamine. In one embodiment, the compound is methylbutylamine. In one embodiment, the compound is an analogue or derivative of methylbutylamine.

### Compounds

One aspect of the invention relates to a method for controlling a rodent, comprising contacting a rodent with a composition comprising a compound of the invention. In certain embodiments, the compound can activate multiple olfactory receptors. In certain embodiments, the compound activates at least one olfactory receptor. In certain embodiments, the compound can be an agonist of olfactory trace amine-associated receptors (TAARs). In certain embodiments, the TAAR is selected from any genes and pseudogenes contained in the rodent's genome.

In certain embodiments, the compound can be an agonist of TAAR4. In certain embodiment, the compound can be isolated from a predator's urine. In certain embodiments, the compound comprises a biogenic amine. In certain embodiment, the compound comprises 2-phenylethylamine. In certain embodiment, the compound comprises N,N-dimethylphenylethylamine. In certain embodiment, the compound comprises N,N-dimethylcyclohexylamine. In certain embodiment, the compound comprises 5-methoxy-N,N-dimethyltryptamine. In certain embodiments, the compound comprises isoamylamine. In certain embodiments, the compound comprises N,N-dimethyloctylamine. In certain embodiments, the compound comprises N,N-dimethylbutylamine. In certain embodiments, the compound comprises 1-methylpiperidine. In certain embodiments, the compound comprises cyclohexylamine. In certain embodiments, the compound comprises methylbutylamine.

In certain embodiments, the compound comprises an analogue of 2-phenylethylamine. In certain embodiments, the compound comprises a derivative of 2-phenylethylamine. In certain embodiments, the compound comprises a precursor of 2-phenylethylamine. In certain embodiment, the compound comprises an analogue of N,N-dimethylphenylethylamine. In certain embodiment, the compound comprises a derivative of N,N-dimethylphenylethylamine. In certain embodiment, the compound comprises a precursor of N,N-dimethylphenylethylamine. In certain embodiment, the compound comprises an analogue of 1-methylpiperidine. In certain embodiment, the compound comprises a derivative of 1-methylpiperidine. In certain embodiment, the compound comprises a precursor of 1-methylpiperidine. In certain embodiment, the compound comprises an analogue of 5-methoxy-N,N-dimethyltryptamine. In certain embodiment, the compound comprises a derivative of 5-methoxy-N,N-dimethyltryptamine. In certain embodiment, the compound comprises a precursor of 5-methoxy-N,N-dimethyltryptamine. In certain embodiment, the compound comprises an anolgue of isoamylamine. In certain embodiment, the compound comprises a derivative of isoamylamine. In certain embodiment, the compound comprises a precursor of isoamylamine. In certain embodiment, the compound comprises an analogue of N,N-dimethyloctylamine. In certain embodiment, the compound comprises a derivative of N,N-dimethyloctylamine. In certain embodiment, the compound comprises a precursor of N,N-dimethyloctylamine. In certain embodiment, the compound comprises an analogue of N,N-dimethylbutylamine. In certain embodiment, the compound comprises a derivative of N,N-dimethylbutylamine In certain embodiment, the compound comprises a precursor of N,N-dimethylbutylamine.

In certain embodiment, the compound comprises an analogue of 1-methylpiperidine. In certain embodiment, the compound comprises a derivative of 1-methylpiperidine. In certain embodiment, the compound comprises a precursor of 1-methylpiperidine.

In certain embodiment, the compound comprises an analogue of cyclohexylamine. In certain embodiment, the compound comprises a derivative of cyclohexylamine. In certain embodiment, the compound comprises a precursor of cyclohexylamine. In certain embodiment, the compound comprises an analogue of methylbutylamine. In certain embodiment, the compound comprises a derivative of methylbutylamine. In certain embodiment, the compound comprises a precursor of methylbutylamine.

### Acceptable Salts and Compositions

All compounds described herein can be used in pure form or in the form of an acceptable salt. Acceptable salts of the compound of the invention can be salts of organic or inorganic acids, such as hydrochloric acid, hydrobromic acid, sulfuric acid, nitric acid, perchloric acid, phosphoric acid, formic acid, acetic acid, trifluoroacetic acid, oxalic acid, malonic acid, toluenesulfonic acid, benzoic acid, terpenoid acids (e.g., abiotic acid), or natural phenolic acids (e.g., gallic acid and its derivatives). Additionally, the compound of any compound of the invention can be included as an active ingredient within a composition, for example, a rodenticide or rodent control agent, in a free form or in the form of an acceptable salt.

A composition includes one or more of the above-described compounds and an acceptable carrier, additive, or adjuvant, and the composition can function as a rodenticide or rodent control agent.

Such compositions can be in the form of a solid, liquid, gas, or gel. If a solid composition is created, suitable solid carriers include agriculturally useful and commercially available powders. Liquid compositions can be aqueous or non-aqueous, depending on the needs of the user applying the composition, and liquids can exist as emulsions, suspensions, or solutions. Exemplary compositions include (but are not limited to) powders, dusts, granulates, topical oils, encapsulations, emulsifiable concentrates, suspension concentrates, directly sprayable or dilutable solutions, coatable pastes, dilute emulsions, wettable powders, soluble powders, dispersible powders, or fumigants.

The particle or droplet size of a particular composition can be altered according to its intended use. The composition also can include an apparatus for containing or dispersing the compound or composition, such as a storage kit, fumigant bottle (such as the commonly named “flea bomb”), or insect trap.

Acceptable carriers, additives, and adjuvants include stabilizers, preservatives, antioxidants, extenders, solvents, surfactants, antifoaming agents, viscosity regulators, binders, tackers, or other chemical agents, such as fertilizers, antibiotics, fungicides, nematicides, or herbicides. Such carriers, additives, and adjuvants can be used in solid, liquid, gas, or gel form, depending on the embodiment and its intended application. Acceptable adjuvants are those materials that assist or enhance the action of a compound or composition. Surfactants and antifoaming agents are just two examples of Acceptable adjuvants. However, any particular material can alternatively function as a “carrier,” “additive,” or “adjuvant” in alternative embodiments, or can fulfill more than one function.

Certain additives, carriers, or adjuvants can be active or inactive materials or substances. In some instances, the efficacy of a composition can be increased by adding one or more other components that minimize toxicity to hosts or increase the anti-rodent effect of the composition.

Additionally, the composition can include plural compounds of the invention. Such a composition includes a compound as described herein and a second compound, and the second compound also can be a compound as described herein, or can be any other type or class compound.

In certain compositions, the second compound, additive, carrier, or adjuvant provides a synergistic effect by increasing the efficacy of the composition more than the additive amount.

The following list of exemplary carriers, additives, and adjuvants is meant to be illustrative, not exhaustive.

Suitable solid carriers, such as those used for dusts and dispersible powders, include natural mineral fillers such as calcite, talcum, kaolin, montmorillonite, and attapulgite. Highly dispersed silicic acids or highly dispersed absorbent polymers can be added to such carriers. Granulated materials of inorganic or organic nature can be used, such as dolomite or pulverized plant residues. Suitable porous granulated adsorptive carriers include pumice, broken brick, sepiolite, and bentonite. Additionally, nonsorbent carriers, such as sand, can be used. Some solid carriers are biodegradable polymers, including biodegradable polymers that are digestible or degrade inside an animal's body over time.

Suitable liquid carriers, such as solvents, can be organic or inorganic. Water is one example of an inorganic liquid carrier. Organic liquid carriers include vegetable oils and epoxidized vegetable oils, such as rape seed oil, castor oil, coconut oil, soybean oil and epoxidized rape seed oil, castor oil, coconut oil, soybean oil, and other essential oils. Other organic liquid carriers include silicone oils, aromatic hydrocarbons, and partially hydrogenated aromatic hydrocarbons, such as alkylbenzenes containing 8 to 12 carbon atoms, including xylene mixtures, alkylated naphthalenes, or tetrahydronaphthalene. Aliphatic or cycloaliphatic hydrocarbons, such as paraffins or cyclohexane, and alcohols, such as ethanol, propanol or butanol, also are suitable organic carriers. Gums, resins, and rosins used in forest products applications and naval stores (and their derivatives) also can be used. Additionally, glycols, including ethers and esters, such as propylene glycol, dipropylene glycol ether, diethylene glycol, 2-methoxyethanol, and 2-ethoxyethanol, and ketones, such as cyclohexanone, isophorone, and diacetone alcohol can be used. Strongly polar organic solvents include N-methylpyrrolid-2-one, dimethyl sulfoxide, and N,N-dimethylformamide.

Suitable surfactants can be nonionic, cationic, or anionic, depending on the nature of the compound used as an active ingredient. Surfactants can be mixed together in some embodiments. Nonionic surfactants include polyglycol ether derivatives of aliphatic or cycloaliphatic alcohols, saturated or unsaturated fatty acids and alkylphenols. Fatty acid esters of polyoxyethylene sorbitan, such as polyoxyethylene sorbitan trioleate, also are suitable nonionic surfactants. Other suitable nonionic surfactants include water-soluble polyadducts of polyethylene oxide with polypropylene glycol, ethylenediaminopolypropylene glycol and alkylpolypropylene glycol. Particular nonionic surfactants include nonylphenol polyethoxyethanols, polyethoxylated castor oil, polyadducts of polypropylene and polyethylene oxide, tributylphenol polyethoxylate, polyethylene glycol and octylphenol polyethoxylate. Cationic surfactants include quaternary ammonium salts carrying, as N-substituents, an 8 to 22 carbon straight or branched chain alkyl radical. The quaternary ammonium salts carrying can include additional substituents, such as unsubstituted or halogenated lower alkyl, benzyl, or hydroxy-lower alkyl radicals. Some such salts exist in the form of halides, methyl sulfates, and ethyl sulfates. Particular salts include stearyldimethylammonium chloride and benzyl bis(2-chloroethyl)ethylammonium bromide. Suitable anionic surfactants can be water-soluble soaps as well as water-soluble synthetic surface-active compounds. Suitable soaps include alkali metal salts, alkaline earth metal salts, and unsubstituted or substituted ammonium salts of higher fatty acids. Particular soaps include the sodium or potassium salts of oleic or stearic acid, or of natural fatty acid mixtures. Synthetic anionic surfactants include fatty sulfonates, fatty sulfates, sulfonated benzimidazole derivatives, and alkylarylsulfonates. Particular synthetic anionic surfactants include the sodium or calcium salt of ligninsulfonic acid, of dodecyl sulfate, or of a mixture of fatty alcohol sulfates obtained from natural fatty acids. Additional examples include alkylarylsulfonates, such as sodium or calcium salts of dodecylbenzenesulfonic acid, or dibutylnaphthalenesulfonic acid. Corresponding phosphates for such anionic surfactants are also suitable.

The concentration of a compound, such as a compound according to any compound of the invention, which serves as an active ingredient, can vary according to particular compositions and applications. In a number of embodiments, the percentage by weight of the active ingredient will be from about 0.1% to about 90%. A suitable amount for a particular application can be determined using bioassays for the particular rodent intended to be controlled. Higher concentrations are usually employed for commercial purposes or products during manufacture, shipment, or storage; such embodiments have concentrations at least about 10%, or from about 25% to about 90% by weight. Prior to use, a highly concentrated formulation can be diluted to a concentration appropriate for the intended use, such as from about 0.1% to 10%, or from about 1% to 5%, or from about 5% to 90%. In any such formulation, the active ingredient can be a compound according to any compound of the invention, a corresponding acceptable salt, or a mixture thereof.

Certain compounds have deterrent, repellent, and/or toxic effects on certain rodent targets and can function as rodent repellents or rodent control agents, as well as rodenticides. Certain compounds have a lethal effect on specific rodents. Unlike a number of commercially available rodent control agent, many compositions have an active ingredients, such as a compound of the invention that are substantially nontoxic to humans and domesticated animals and that have minimal adverse effects on wildlife and the environment.

In some embodiments, the efficacy of a subject compound or composition is determined from an adverse effect on the rodent population, including (but not limited to) physiological damage to a rodent, inhibition or modulation of rodent growth, inhibition or modulation of rodent reproduction by slowing or arresting proliferation, inhibition or complete deterrence of rodent movement from a locus, initiation or promotion of rodent movement away from a locus, inhibition or elimination of rodent feeding activity, or death of the rodent, all of which are encompassed by the term “controlling.” Thus, a compound or composition that controls a rodent (i.e., a rodent control agent or rodenticide) adversely affects its presence, status, and/or physiological condition at a locus. The efficacy and quantity of a rodent control agent effective amount for a given compound can be determined by routine screening procedures employed to evaluate deterring activity and efficacy, such as those screening described in the Examples.

In some embodiments, efficacy and appropriateness of a compound also can be assessed by treating an animal, plant, or environmental locus with a compound or composition described herein and observing the effects on the infesting rodent population and any harm to plants or animals contacted by the compound, such as phytotoxicity to plants, toxicity to animals, or dermal sensitivity to animals. For example, in certain embodiments, compounds or compositions are directly applied to a locus potentially infested with a rodent. In such embodiments, the efficacy of the compound or composition can be monitored by examining the state of the locus infestation by the rodent population before and after application in light of damage to the locus by the rodent population. Additionally, the appropriateness of a compound or composition can be assessed by observing any adverse effects to the person applying the composition to an infested plant, animal, or environmental locus. In particular embodiments, the effective amount of a compound or composition meets the mortality, modulation, or control criteria above, and has minimal or no adverse effect on plants, non-human animals, or humans that can come into contact with the compound or composition.

The compounds and compositions have a broad range of biocidal effects, such as rodenticidal activity against one or more rodents, and certain compounds and/or compositions can be more effective on some rodents than others. Some compounds of the invention, or compositions containing such compounds, can be partially or totally ineffective against some rodents at certain concentrations. However, any differences in efficacy should not in any way detract from the utility of these compounds or compositions, or their methods of use, since some of these compounds or compositions can function as broad, general acting rodent control agents, while other compounds or compositions can function as specific or selective rodent control agents. The Examples set forth below illustrate methods by which the degree of selectivity of rodent control activity can be readily ascertained.

The compounds and compositions described herein can be used for controlling rodents in natural and artificial environments. The compound or composition can be applied to plant and animal parts (e.g., skin, fur, feathers, scales, leaves, flowers, branches, fruits) and to objects within an environment that come into contact with a rodent. Additionally, the compound or composition can be included as part of an object held or placed upon a prospective host plant or animal to inhibit rodent infestation, such as a collar, clothing, or supporting mechanism (e.g., a stake supporting a seedling tree, a rose trellis, or a cage for supporting a tomato plant).

The compounds and compositions have useful inhibitory and/or curative properties in the field of rodent control, even at low concentrations, and can be used as part of an integrated rodent management program. These and other methods of using the compounds and compositions are further described below.

### Methods and Uses

One aspect of the invention relates to a method for controlling a rodent, comprising contacting a rodent with a composition comprising a compound of the invention. In certain embodiments, controlling the rodent comprises repelling the rodent.

In certain embodiments, controlling the rodent comprises reducing the rodent population in a given area.

In certain embodiment, contacting the rodent with a compound comprises the rodent inhaling the compound. In certain embodiment, contacting the rodent with a compound comprises the rodent absorbing the compound. In certain embodiment, contacting the rodent with a compound comprises the rodent ingesting the compound. In certain embodiment, contacting the rodent with a compound comprises the rodent having a dermal, ocular or mucosal contact with the compound.

In certain embodiments, the method comprises applying to a locus from which said rodent is to be deterred a compound of the invention.

In certain embodiments, the method comprises an area-wide application of the compound to a locus. In certain embodiment, the area-wide application comprises applying a compound of the invention around the perimeter of a locus. In certain embodiment, the area-wide application comprises applying a compound of the invention to chosen location of the locus. In certain embodiments, the area-wide application comprises contacting the majority of the locus with a compound of the invention. In certain embodiments, the application comprises spraying. In certain embodiments, the application comprises placing at least one delivery device comprising the compound of the invention at a chosen location. In certain embodiments, the application comprises placing at least two delivery devices comprising the compound of the invention at chosen intervals.

In certain embodiments, the locus is a silo containing grains. In certain embodiments, the locus is a grain storage. In certain embodiments, the locus is a residential basement. In certain embodiments, the locus is a commercial basement. In certain embodiments, the locus is a locus comprising a rodent population greater than desired.

In certain embodiments, the method comprises embedding the compound in a material. In certain embodiments, the material is a siding, wall studs, or beam. In certain embodiments, the material is a fabric. In certain embodiments, the material is cotton or gauze. In certain embodiments, the compound is applied to plants, animals or objects within an environment that comes into contact with the rodent.

In certain embodiments, the compound is in a delivery device which allows for releasing said compound in the air. In certain embodiments, the delivery device is a spray bottle. In certain embodiments, the delivery device is a spray bottle with a hose connection. In certain embodiments, the delivery device is a pressurized aerosol. In certain embodiments, the delivery device is a grenade-like delivery device.

One aspect of the invention relates to a delivery device comprising at least one compound of the invention. In one embodiment, the delivery device allows for release of the compound in the air. In one embodiment, the delivery device is a partial sealed delivery device which allows for slow release of the compound. In certain embodiments, the delivery device is a spray bottle. In certain embodiments, the delivery device is a spray bottle with a hose connection. In one embodiment, the delivery device is a pressurized aerosol dispensing delivery device. In one embodiment, the delivery device is a grenade-like delivery device.

### Equivalents

The representative examples which follow are intended to help illustrate the invention, and are not intended to, nor should they be construed to, limit the scope of the invention. Indeed, various modifications of the invention and many further embodiments thereof, in addition to those shown and described herein, will become apparent to those skilled in the art from the full contents of this document, including the examples which follow and the references to the scientific and patent literature cited herein. It should further be appreciated that, unless otherwise indicated, the entire contents of each of the references cited herein are incorporated herein by reference to help illustrate the state of the art. The following examples contain important additional information, exemplification and guidance which can be adapted to the practice of this invention in its various embodiments and the equivalents thereof.

These and other aspects of the present invention will be further appreciated upon consideration of the following Examples, which are intended to illustrate certain particular embodiments of the invention but are not intended to limit its scope, as defined by the claims.

The invention can be defined by any of the following numbered paragraphs:
1. A method for controlling a rodent, comprising contacting a rodent with a composition comprising 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, cyclohexaylamine, methylbutylamine, a derivative, or an analogue thereof.
2. The method of paragraph 1, wherein controlling the rodent comprises repelling the rodent.
3. The method of paragraph 1, wherein the method comprises an area-wide application comprising 2-phenylethylamine, N,N-dimethylcyclohexylamine, 5-methoxy-N,N-dimethyltryptamine, N,N-dimethylphenylethylamine, 1-methylpiperidine, or a combination thereof.
4. The method of paragraph 1, wherein 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, cyclohexaylamine, methylbutylamine or a combination thereof is embedded within a material.
5. The method of paragraph 4, wherein the material is a siding, wall studs, or beam.
6. The method of paragraph 1, wherein 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, cyclohexaylamine, methylbutylamine or a combination thereof is applied to plants, animals or objects within an environment that comes into contact with the rodent.
7. The method of paragraph 1, wherein 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, cyclohexaylamine, methylbutylamine or a combination thereof is in a delivery device which allows for releasing said compound in the air.
8. A delivery device comprising 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, cyclohexaylamine, methylbutylamine or a combination thereof, wherein the delivery device allows for release on the compound in the air.
9. A method for controlling a rodent, comprising contacting a rodent with a composition comprising a ligand of at least one TAAR.

### Some Selected Definitions

Certain compounds of the present invention and definitions of specific functional groups are also described in more detail below. For purposes of this invention, the chemical elements are identified in accordance with the Periodic Table of the Elements, CAS version, Handbook of Chemistry and Physics, 75th Ed., inside cover, and specific functional groups are generally defined as described therein.

It will be appreciated that the compounds, as described herein, can be substituted with any number of substituents or functional moieties. In general, the term “substituted” whether preceded by the term “optionally” or not, and substituents contained in formulas of this invention, refer to the replacement of hydrogen radicals in a given structure with the radical of a specified substituent. When more than one position in any given structure can be substituted with more than one substituent selected from a specified group, the substituent can be either the same or different at every position. As used herein, the term “substituted” is contemplated to include all permissible substituents of organic compounds. In a broad aspect, the permissible substituents include acyclic and cyclic, branched and unbranched, carbocyclic and heterocyclic, aromatic and nonaromatic substituents of organic compounds. For purposes of this invention, heteroatoms such as nitrogen can have hydrogen substituents and/or any permissible substituents of organic compounds described herein which satisfy the valencies of the heteroatoms. Furthermore, this invention is not intended to be limited in any manner by the permissible substituents of organic compounds. The term “stable”, as used herein, preferably refers to compounds which possess stability sufficient to allow manufacture and which maintain the integrity of the compound for a sufficient period of time to be detected and preferably for a sufficient period of time to be useful for the purposes described herein.

“Compound”: The term “compound” or “chemical compound” as used herein can include organometallic compounds, organic compounds, metals, transitional metal complexes, and small molecules, or any mixture thereof.

“Small Molecule”: As used herein, the term “small molecule” refers to a non-peptidic, non-oligomeric organic compound, either synthesized in the laboratory or found in nature. A small molecule is typically characterized in that it contains several carbon-carbon bonds, and has a molecular weight of less than 2000 g/mol, preferably less than 1500 g/mol, although this characterization is not intended to be limiting for the purposes of the present invention. Examples of “small molecules” that occur in nature include, but are not limited to, taxol, dynemicity and rapamycin, Examples of “small molecules” that are synthesized in the laboratory include, but are not limited to, compounds described in Tan et al., (“Stereoselective Synthesis of over Two Million Compounds Having Structural Features Both Reminiscent of Natural Products and Compatible with Miniaturized Cell-Based Assays” J. Am. Chem. Soc. 1998, 120, 8565; incorporated herein by reference).

As used herein, the singular forms “a,” “an,” and “the,” refer to both the singular as well as plural, unless the context clearly indicates otherwise. For example, the term “a rodenticidal compound” includes single or plural rodenticidal compounds and can be considered equivalent to the phrase “at least one rodenticidal compound.”

As used herein, the term “comprises” means “includes.” For example, “comprising A or B” means “includes A,” “includes B,” or “includes both A and B.”

An “analog” is a molecule that differs in chemical structure from a parent compound. Examples include, but are not limited to: a homolog (which differs by an increment in the chemical structure, such as a difference in the length of an alkyl chain); a molecular fragment; a structure that differs by one or more functional groups; or a structure that differs by a change in ionization, such as a radical. Structural analogs are often found using quantitative structure activity relationships (QSAR), with techniques such as those disclosed in Remington: The Science and Practice of Pharmacology, 19.sup.th Edition (1995), chapter 28.

A “derivative” is a biologically active molecule derived from the base molecular structure. A mimetic is a biomolecule that mimics the activity of another biologically active molecule. Biologically active molecules can include chemical compounds that mimic the deterring activities of the compounds disclosed herein.

As used herein, the terms “alkyl,” “alkenyl” and the prefix “alk-” are inclusive of both straight chain and branched chain groups and of cyclic groups, e.g., cycloalkyl and cycloalkenyl. Unless otherwise specified, these groups contain from 1 to 20 carbon atoms, with alkenyl groups containing from 2 to 20 carbon atoms. Preferred groups have a total of up to 10 carbon atoms. Cyclic groups can be monocyclic or polycyclic and preferably have from 3 to 10 ring carbon atoms. Exemplary cyclic groups include cyclopropyl, cyclopentyl, cyclohexyl, cyclopropylmethyl, adamantly, norbornane, and norbornene. This is also true of groups that include the prefix “alkyl-,” such as alkylcarboxylic acid, alkyl alcohol, alkylcarboxylate, alkylaryl, and the like. Examples of suitable alkylcarboxylic acid groups are methylcarboxylic acid, ethylcarboxylic acid, and the like. Examples of suitable alkylacohols are methylalcohol, ethylalcohol, isopropylalcohol, 2-methylpropan-1-ol, and the like. Examples of suitable alkylcarboxylates are methylcarboxylate, ethylcarboxylate, and the like. Examples of suitable alkyl aryl groups are benzyl, phenylpropyl, and the like.

These may be straight chain or branched, saturated or unsaturated aliphatic hydrocarbon, which may be optionally inserted with N, O, or S. Representative saturated straight chain alkyls include methyl, ethyl, n-propyl, n-butyl, n-pentyl, n-hexyl, and the like; while saturated branched alkyls include isopropyl, sec-butyl, isobutyl, tert-butyl, isopentyl, and the like.

As used herein, the term “alkenyl” means an alkyl, as defined above, containing at least one double bond between adjacent carbon atoms. Alkenyls include both cis and trans isomers. Representative straight chain and branched alkenyls include ethylenyl, propylenyl, 1-butenyl, 2-butenyl, isobutylenyl, 1-pentenyl, 2-pentenyl, 3-methyl-1-butenyl, 2-methyl-2-butenyl, 2,3-dimethyl-2-butenyl, and the like.

As used herein, the term “alkynyl” means any alkyl or alkenyl, as defined above, which additionally contains at least one triple bond between adjacent carbons. Representative straight chain and branched alkynyls include acetylenyl, propynyl, 1-butynyl, 2-butynyl, 1-pentynyl, 2-pentynyl, 3-methyl-1 butynyl, and the like.

The term “aryl” as used herein includes carbocyclic aromatic rings or ring systems. Examples of aryl groups include phenyl, naphthyl, biphenyl, fluorenyl and indenyl. The term “heteroaryl” includes aromatic rings or ring systems that contain at least one ring hetero atom (e.g., O, S, N). Suitable heteroaryl groups include furyl, thienyl, pyridyl, quinolinyl, isoquinolinyl, indolyl, isoindolyl, thiazolyl, pyrrolyl, tetrazolyl, imidazolyl, pyrazolyl, oxazolyl, thiazolyl, benzofuranyl, benzothiophenyl, carbazolyl, benzoxazolyl, pyrimidinyl, benzimidazolyl, quinoxalinyl, benzothiazolyl, naphthyridinyl, isoxazolyl, isothiazolyl, purinyl, quinazolinyl, and so on.

The aryl, and heteroaryl groups can be unsubstituted or substituted by one or more substituents independently selected from the group consisting of alkyl, alkoxy, methylenedioxy, ethylenedioxy, alkylthio, haloalkyl, haoalkoxy, haloalkylthio, halogen, nitro, hydroxy, mercapto, cyano, carboxy, formyl, aryl, aryloxy, arylthio, arylalkoxy, arylalkylthio, heteroaryl, heteroaryloxy, heteroarylalkoxy, heteroarylalkylthio, amino, alkylamino, dialkylamino, heterocyclyl, heterocycloalkyl, alkylcarbonyl, alkenylcarbonyl, alkoxycarbonyl, haloalkylcarbonyl, haloalkoxycarbonyl, alkylthiocarbonyl, arylcarbonyl, heteroarylcarbonyl, aryloxycarbonyl, heteroaryloxycarbonyl, arylthiocarbonyl, heteroarylthiocarbonyl, alkanoyloxy, alkanoylthio, alkanoylamino, arylcarbonyloxy, arylcarbonylhio, alkylaminosulfonyl, alkylsulfonyl, arylsulfonyl, heteroarylsulfonyl, aryldiazinyl, alkylsulfonylamino, arylsulfonylamino, arylalkylsulfonylamino, alkylcarbonylamino, alkenylcarbonylamino, arylcarbonylamino, arylalkylcarbonylamino, arylcarbonylaminoalkyl, heteroarylcarbonylamino, heteroarylalkycarbonylamino, alkylsulfonylamino, alkenylsulfonylamino, arylsulfonylamino, arylalkylsulfonylamino, heteroarylsulfonylamino, heteroarylalkylsulfonylamino, alkylaminocarbonylamino, alkenylaminocarbonylamino, arylaminocarbonylamino, arylalkylaminocarbonylamino, heteroarylaminocarbonylamino, heteroarylalkylaminocarbonylamino and, in the case of heterocyclyl, oxo. If other groups are described as being “substituted” or “optionally substituted,” then those groups can also be substituted by one or more of the above enumerated substituents.

As used herein, the term “cyclyl” refers to a nonaromatic 5-8 membered monocyclic, 8-12 membered bicyclic, or 11-14 membered tricyclic ring system, which can be saturated or partially unsaturated. Representative saturated cyclyl groups include, but are not limited to, cyclopropyl, cyclobutyl, cyclopentyl, cyclopentenyl, cyclohexyl, cyclohexenyl, cycloheptyl, cyclooctyl, and the like; while unsaturated cyclyl groups include cyclopentenyl and cyclohexenyl, and the like.

As used herein, the term “heterocyclyl” refers to a nonaromatic 5-8 membered monocyclic, 8-12 membered bicyclic, or 11-14 membered tricyclic ring system having 1-3 heteroatoms if monocyclic, 1-6 heteroatoms if bicyclic, or 1-9 heteroatoms if tricyclic, said heteroatoms selected from O, N, or S (e.g., carbon atoms and 1-3, 1-6, or 1-9 heteroatoms of N, O, or S if monocyclic, bicyclic, or tricyclic, respectively), wherein 0, 1, 2 or 3 atoms of each ring may be substituted by a substituent. Examples of heterocyclyl groups include piperazinyl, pyrrolidinyl, dioxanyl, morpholinyl, tetrahydrofuranyl, among others.

An “animal” is a living multicellular vertebrate organism, a category which includes, for example, mammals, reptiles, arthropods, and birds.

The term “host” includes animal, plant, and fungal hosts.

The term “mammal” includes both human and non-human mammals. As used herein, the term “rodent” refer to common rodent such as mice, rats, squirrels, gerbils, porcupines, beavers, chipmunks, guinea pigs, and voles; as well as any member of the Suborder Anomaluromorpha; Family Anomaluridae: scaly-tailed squirrels; Family Pedetidae: springhares; the Suborder Castorimorpha; Superfamily Castoroidea; Family Castoridae: beavers; Superfamily Geomyoidea; Family Geomyidae: pocket gophers (true gophers); Family Heteromyidae: kangaroo rats and kangaroo mice; Suborder Hystricomorpha; Family incertae sedis Diatomyidae: Laotian rock rat; Infraorder Ctenodactylomorphi; Family Ctenodactylidae: gundis; Infraorder Hystricognathi; Family Bathyergidae: African mole rats; Family Hystricidae: Old World porcupines; Family Petromuridae: dassie rat; Family Thryonomyidae: cane rats; Parvorder Caviomorpha; Family Heptaxodontidae: giant hutias; Family Abrocomidae: chinchilla rats; Family Capromyidae: hutias; Family Caviidae: cavies, including guinea pigs and the capybara; Family Chinchillidae: chinchillas and Viscachas; Family Ctenomyidae: tuco-tucos; Family Dasyproctidae: agoutis; Family Cuniculidae: pacas; Family Dinomyidae: pacaranas; Family Echimyidae: spiny rats; Family Erethizontidae: New World porcupines; Family Myocastoridae: nutria, coypu; Family Octodontidae: octodonts; Suborder Myomorpha; Superfamily Dipodoidea; Family Dipodidae: jerboas and jumping mice; Superfamily Muroidea; Family Calomyscidae: mouse-like hamsters; Family Cricetidae: hamsters, New World rats and mice, voles; Family Muridae: true mice and rats, gerbils, spiny mice, crested rat; Family Nesomyidae: climbing mice, rock mice, white-tailed rat, Malagasy rats and mice; Family Platacanthomyidae: spiny dormice; Family Spalacidae: mole rats, bamboo rats, and zokors; Suborder Sciuromorpha; Family Aplodontiidae: mountain beaver; Family Gliridae (also Myoxidae, Muscardinidae): dormice; Family Sciuridae: squirrels, including chipmunks, prairie dogs, & marmots.

A “rodent control agent” can a compound or composition that controls the behavior of a rodent. In certain embodiments, the behavior can be controlled by causing an adverse effect on that rodent, including (but not limited to) physiological damage to the rodent; activation of sensory receptor; inhibition or modulation of rodent growth; inhibition or modulation of rodent reproduction; inhibition or complete deterrence of rodent movement into a locus; initiation or promotion of rodent movement away from a locus; inhibition or complete suppression of rodent feeding activity; or death of the rodent. A rodent control agent can be considered a “rodenticide” if it kills at least one individual in a rodent population. Additionally, a rodent control agent can be non-lethal at a particular concentration or amount (such as a deterrent of rodents) and a rodenticide at a different concentration or amount. A “rodenticidally effective amount” of a compound refers to an amount that has an adverse biological effect on at least some of the rodents exposed to the rodenticide or rodent control agent. For example, the effective amount of a compound can be an amount sufficient to repel a rodent from a locus, induce sterility in a rodent, or inhibit oviposition in a rodent. A rodenticidally effective amount, or an amount sufficient to inhibit infestation, for a given compound can be determined by routine screening procedures employed to evaluate rodenticidal activity and efficacy. The term “control” refers to the initiation, promotion, instigation, commencement of rodent movement away from a locus.

The term “amount sufficient to inhibit infestation” refers to that amount sufficient to deter, depress, or repel a portion of a rodent population so that a disease or infected state in a host population is inhibited or avoided.

The term “contacting” comprises and is not limited to inhalation, absorption ingestion, and dermal, ocular or mucosal contact.

Compounds or compositions having a higher level of deterring activity can be used in smaller amounts and concentrations, while compounds or compositions having a lower level of deterring activity can require larger amounts or concentrations in order to achieve the same deterring effect. Additionally, some compounds or compositions demonstrating deterring activity can demonstrate non-lethal rodent control effects at a different concentration or amount, such as a lower concentration or amount. Non-lethal rodent control effects include anti-feeding, reduced fecundity, sterility, deterring, and diminished rodent population on a given area.

To the extent not already indicated, it will be understood by those of ordinary skill in the art that any one of the various embodiments herein described and illustrated can be further modified to incorporate features shown in any of the other embodiments disclosed herein.

The following examples illustrate some embodiments and aspects of the invention. It will be apparent to those skilled in the relevant art that various modifications, additions, substitutions, and the like can be performed without altering the spirit or scope of the invention, and such modifications and variations are encompassed within the scope of the invention as defined in the claims which follow. The following examples do not in any way limit the invention.

### EXAMPLES

### Materials and Methods

Chemicals Tested for mTAAR Agonism.

Chemicals tested for the ability to activate mouse TAARs include those previously described (Liberles, S. D., and Buck, L. B. (2006) A second class of chemosensory receptors in the olfactory epithelium, Nature 442, 645-650), as well as the following mixes (5 μM of each indicated compounds). Mix 1: N,N-dimethyl-cyclohexylamine, N,N-dimethyl-phenylethylamine, creatinine, taurine. Mix 2: N-methyl-pyrrolidine, N,N-dimethyl-octylamine, N,N-dimethyl-butylamine, N,N-dimethyl-isopropylamine. Mix 3: N-methyl-proline, N-methyl-glycine, 4-(dimethylamino)-butyric acid, 3-(dimethylamino)-benzoic acid. Mix 4: 2-dimethylamino-2-methyl-1-propanol, 3-dimethylamino-1-propanol, 1-dimethylamino-2-propanol. Mix 5: N,N-dimethyl-p-phenylenediamine, N,N-dimethyl-ethylenediamine, tetramethyl-1,4-butanediamine, 2-(dimethylamino)-ethanethiol. Mix 6: pyridine N-oxide, N,N-dimethyl-benzylamine, N,N-dimethyl-aniline, N,N-dimethyl-1-naphtylamine. Mix 7: 6-(dimethylamino)-purine, 2-dimethylamino-6-hydroxypurine, 5-methoxy-N,N-dimethyltryptamine, 1-methylindole, gramine. Mix 8: dansyl cadaverine, dimethylurea, (dimethylamino)-acetaldehyde-diethylacetal, N,N-dimethyl-acetamide, 3-(dimethylamino)-propiophenone.

Chemicals Tested for rTAAR Agonism.

The following mixes (10 μM of each indicated compounds) were tested for their ability to activate rat TAARs. Mix 1: butylamine, dibutylamine, hexylamine. Mix 2: 2-aminopentane, isoamylamine, isobutylamine, isopropylamine. Mix 3: N,N-dimethylcyclohexylamine, 1-methylindole, tryptamine, phenylethylamine. Mix 4: indole, 1-methylpyrrolidine, 1-methylpiperidine, pyrrolidine. Mix 5: ethylenediamine, cadaverine dihydrochloride, 1,4-diaminobutane dihydrochloride. Mix 6: benzylamine, 1-methylhistamine dihydrochloride, histamine dihydrochloride. Mix 7: GABA, β-alanine, cystamine dihydrochloride, histamine dihydrochloride. Mix 8: methylamine, dimethylamine, trimethylamine. Mix 9: tyramine hydrochloride, octopamine hydrochloride, 3-methoxytyramine, 3,4-dimethoxyphenethylamine, 4-methoxyphenethylamine, N,N-dimethylphenethylamine. Mix 10: 5-hydroxyindole-3-acetic acid, 5-aminoindole hydrochloride, 5-methoxytryptamine, 5-methoxy-N,N-dimethyltryptamine, gramine. Mix 11: aniline hydrochloride, A-naphtylamine. Mix 12: 2,5-dimethylpyrazine, 3-(dimethylamino)-propiophenone. Mix 13: agmatine sulfate, tetramethylammonium chloride, creatinine hydrochloride, 1-(2-aminoethyl)-pyrrolidine, tetramethyl-1,4-butanediamine. Mix 14: 2-methylbutylamine, 3-(methylthio)-propylamine, cyclohexylamine, N,N-dimethylbenzoic acid, N,N-dimethylisopropylamine. Mix 15: cysteamine hydrochloride, amino-2-propanol, N,N-dimethylethanol amine, 1-dimethylamine-2-propanol, 2-(dimethylamino)-ethanethiol. Mix 16: 4-aminobenzoic acid, N,N-dimethylglycine hydrochloride, taurine.

TAAR Functional Assays.

Full Taar coding regions were cloned into pcDNA3.1-(Invitrogen) with or without a 5′ DNA extension of 69 bp encoding the first 20 amino acids of bovine rhodopsin followed by a cloning linker (GCGGCCGCC). Point mutations were introduced in mTAAR7e and mTAAR7f by overlap extension PCR. Functional assays were performed as described (Liberles, S. D., and Buck, L. B. (2006) A second class of chemosensory receptors in the olfactory epithelium, Nature 442, 645-650, Ferrero, D. M., Lemon, J. K., Fluegge, D., Pashkovski, S. L., Korzan, W. J., Datta, S. R., Spehr, M., Fendt, M., and Liberles, S. D. Detection and avoidance of a carnivore odor by prey, Proc Natl Acad Sci USA 108, 11235-11240). Fluorescence was measured on an EnVision plate reader (Perkin Elmer) and SEAP activity graphed as relative fluorescence of a phosphatase substrate.

Phylogenetic Analysis.

Full-length Taar coding sequences were aligned with the multiple sequence alignment program MAFFT (Multiple Alignment using Fast Fourier Transform) (3), using a mouse olfactory receptor (MOR-1362) and five mouse biogenic amine receptors (histamine H2 receptor, serotonin 1a and 5a receptors, dopamine 2 and 3 receptors) as outgroups. The best-fitting nucleotide substitution model, GTR+I+Γ, was selected using Akaike Information Criterion (AIC) implemented in the program MRMODELTEST (Posada, D., and Crandall, K. A. (1998) MODELTEST: testing the model of DNA substitution, Bioinformatics 14, 817-818.). The phylogenetic tree was constructed using the program MRBAYES 3.1.2 (Ronquist, F., and Huelsenbeck, J. P. (2003) MrBayes 3: Bayesian phylogenetic inference under mixed models, Bioinformatics 19, 1572-1574) using default priors, except for the branch length prior for which an exponential distribution with unconstrained values was used. MRBAYES was run for 10,000,000 generations with 4 Markov chains, and sampling occurred every 1,000 generations. The trees from the first 1,000,000 generations were discarded as burn-in. Nodal support values were estimated by Bayesian posterior probabilities.

Generation of mTAAR Homology Models.

3D models of mTAAR7e and mTAAR7f were generated with the molecular modeling package ICM (Version 3.6.-1b, Molsoft LLC) that uses the ZEGA alignment algorithm (Abagyan, R. A., and Batalov, S. (1997) Do aligned sequences share the same fold?, J Mol Biol 273, 355-368) and the standard modeling function BuildModel (Cardozo, T., Totrov, M., and Abagyan, R. (1995) Homology modeling by the ICM method, Proteins 23, 403-414). Both models were based on the structure of the nanobody stabilized β₂ adrenergic receptor (β₂AR) bound to the agonist BI-167107 (PDB ID: 3P0G) (Rasmussen, S. G., Choi, H. J., Fung, J. J., Pardon, E., Casarosa, P., Chae, P. S., Devree, B. T., Rosenbaum, D. M., Thian, F. S., Kobilka, T. S., Schnapp, A., Konetzki, I., Sunahara, R. K., Gellman, S. H., Pautsch, A., Steyaert, J., Weis, W. I., and Kobilka, B. K. Structure of a nanobody-stabilized active state of the beta(2) adrenoceptor, Nature 469, 175-180), using only the receptor coordinates. The alignment between the TAARs and the structured regions of β₂AR shows 33% sequence similarity and it was manually adjusted to eliminate minor gaps in TM helix I and the C-terminus. Intracellular loop 3 (ICL3) of both mTAARs was not aligned since the β₂AR construct contains a T4 Lysozyme molecule that replaces ICL3 but is disordered in the structure. A limited energy-based optimization of side chains and loops was done after the coordinates were placed according to the alignment and the 3P0G coordinates. The ligands were placed into the models using COOT (Emsley, P., Lohkamp, B., Scott, W. G., and Cowtan, K. Features and development of Coot, Acta Crystallogr D Biol Crystallogr 66, 486-501.) and the data was evaluated and figures were made in PyMOL.

### Example 1

### Identification of a Predator Odor

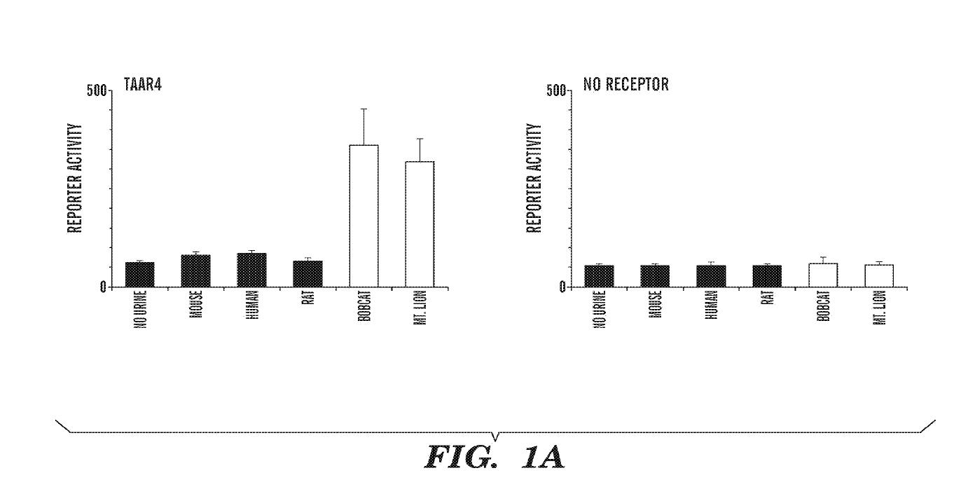

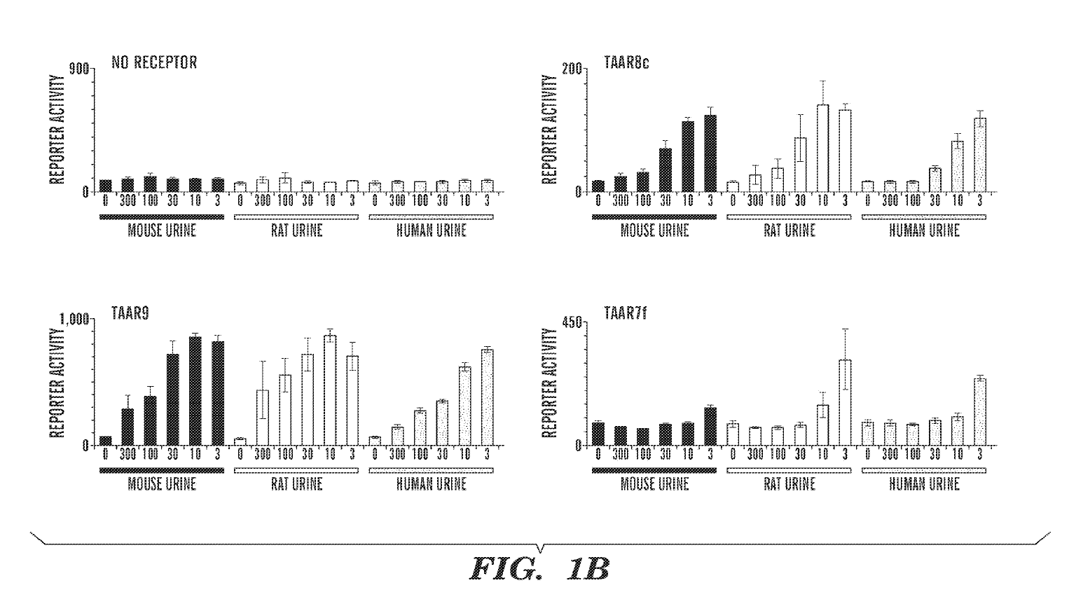

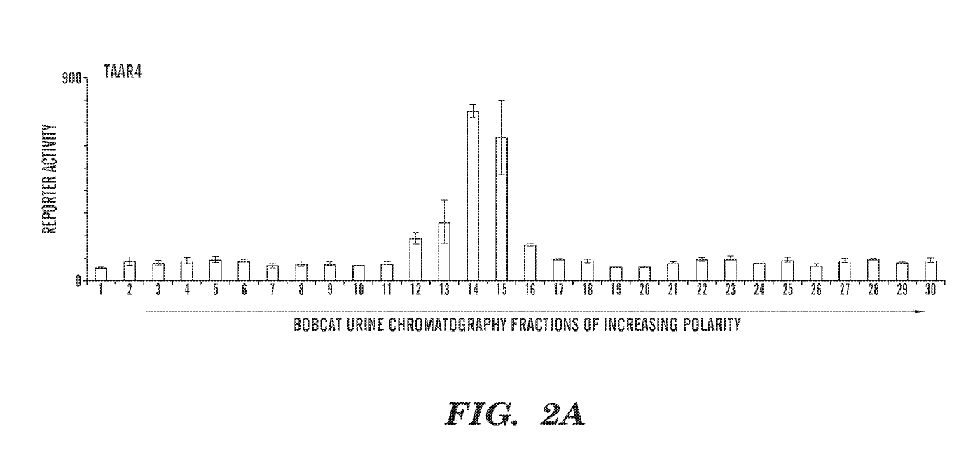

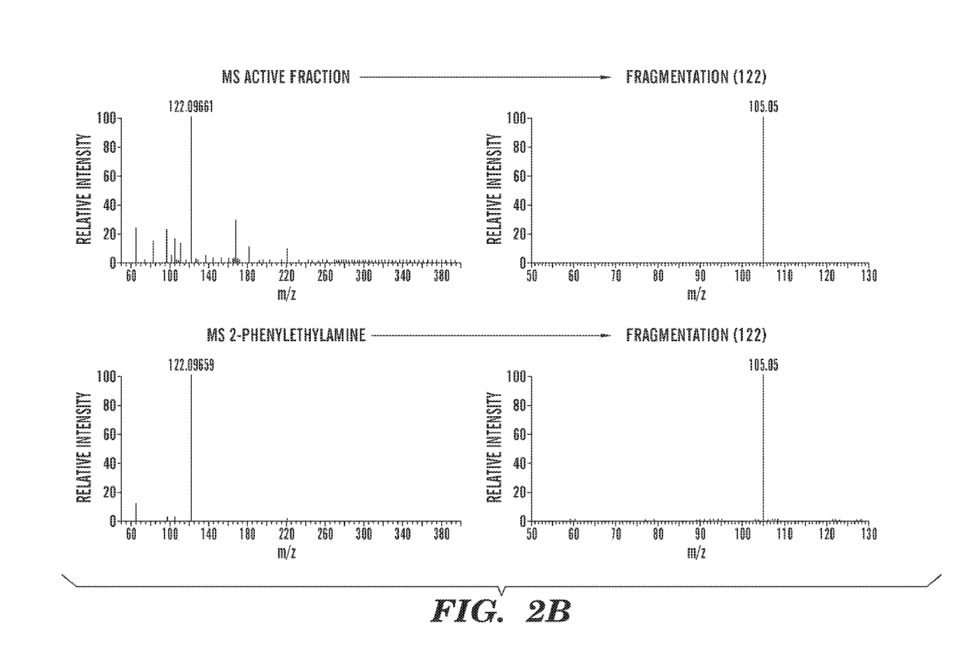

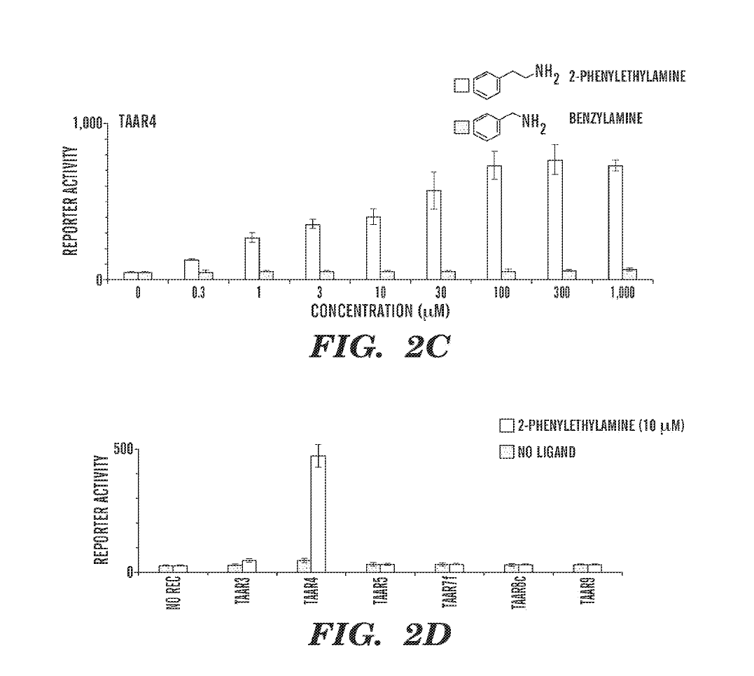

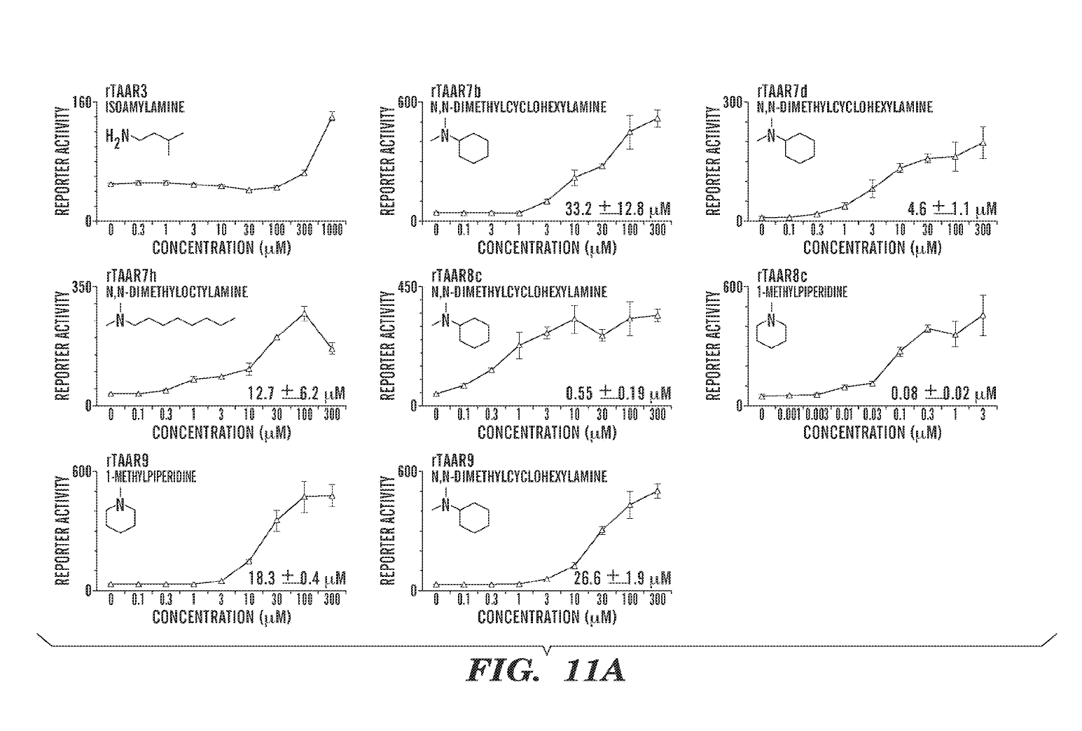

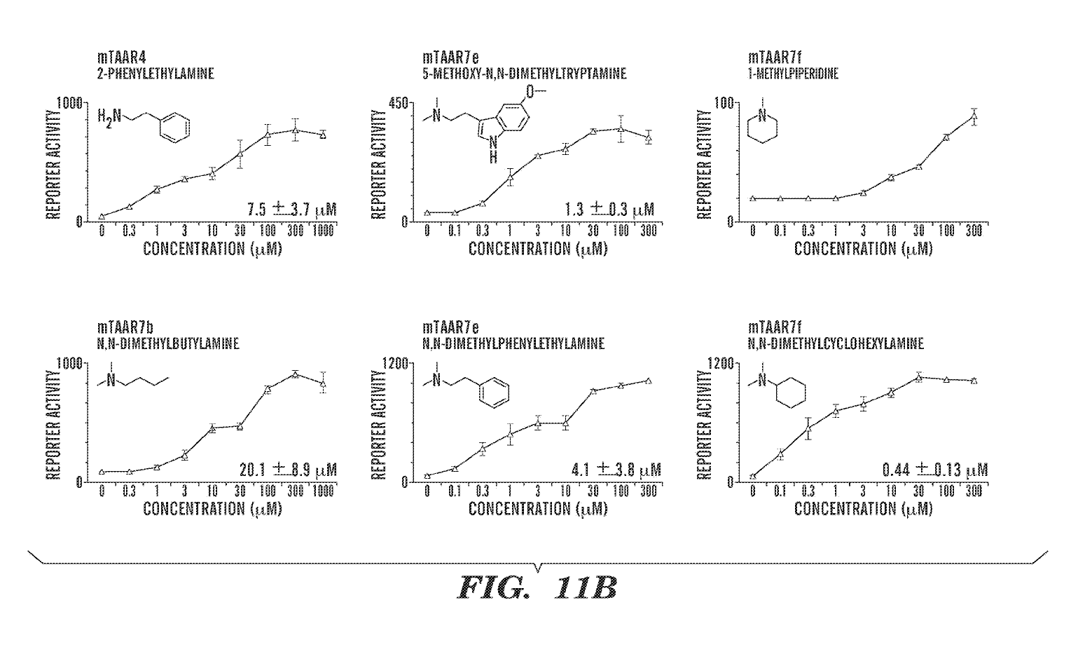

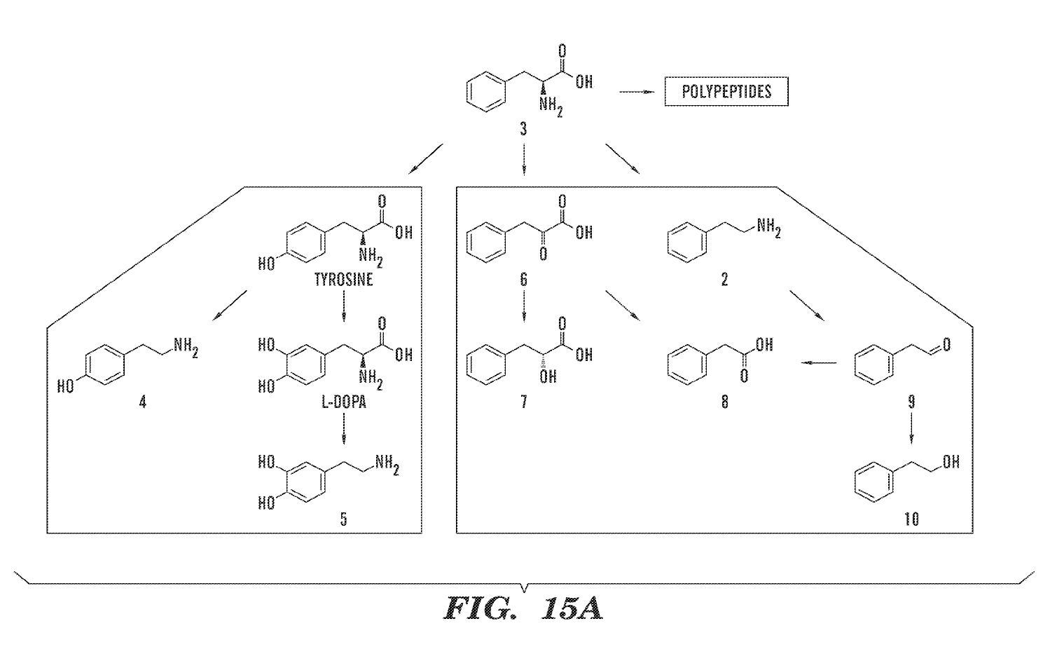

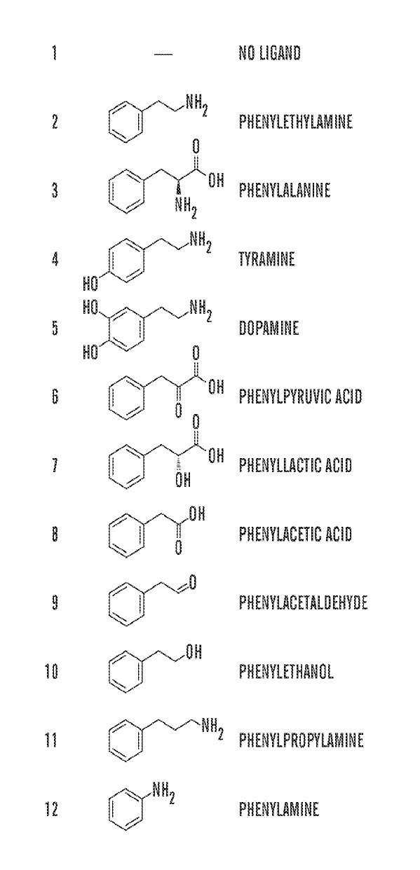

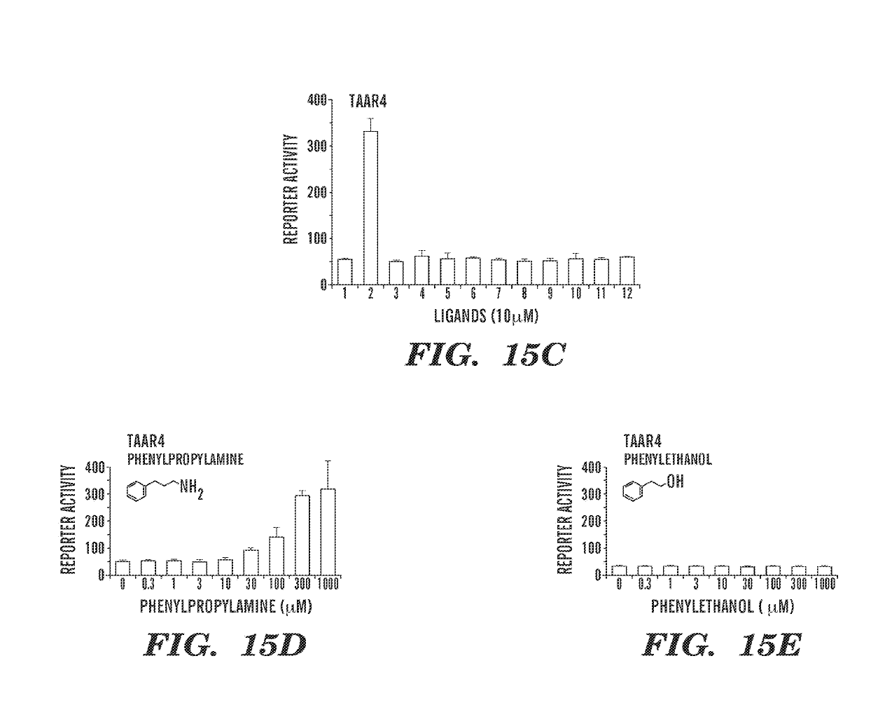

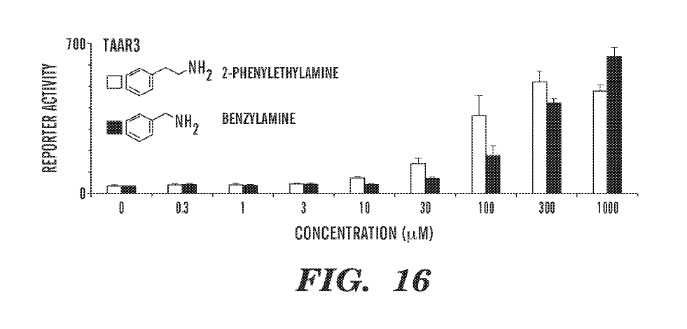

In the course of identifying natural and synthetic ligands for olfactory trace amine-associated receptors (TAARs) (10), we found that mouse TAAR4 selectively detects the urine of several carnivore species (FIG. 1A). HEK293 cells were co-transfected with TAAR expression plasmids and a cAMPdependent reporter gene encoding secreted alkaline phosphatase (CRE-SEAP). Transfected cells were incubated with urine extracts from different mammalian species, and phosphatase activity was quantified with a fluorescent substrate as a reporter for TAAR activation. Urine extracts (10-fold dilution) from bobcat and mountain lion activated TAAR4 while rodent and human urine extracts did not. Responses to predator odors were not observed in control cells transfected with reporter gene alone. Three other TAARs-TAAR7f, TAAR8c, and TAAR9-detected natural products common to urine of numerous mammalian species, including mouse, rat, human, and carnivores (FIG. 1B, FIG. 11). However, these receptors detect carnivore and non-carnivore urines with similar sensitivity. We reasoned that TAAR4 detected a specific chemical enriched in predator urine, and that this cue can function as a kairomone. We used a chemical fractionation approach to purify and characterize the predator urineenriched activator. Basic dichloromethane extracts of bobcat urine were separated by silica gel chromatography, and fractions analyzed with the reporter gene assay (FIG. 2A). Several chromatography fractions containing the TAAR4 activator were obtained and analyzed by mass spectrometry (FIG. 2B). A constituent was detected with exactly the same mass (m/z=122) as ionized 2-phenylethylamine. Furthermore, fragmentation of this constituent and detection by tandem mass spectrometry identified a daughter ion (m/z=105) corresponding to neutral loss of ammonia, an identical fragmentation pattern to that observed with 2-phenylethylamine. Commercially available 2-phenylethylamine was a potent activator of TAAR4 (EC50=˜2□M), while related amines with small perturbations in structure, such as benzylamine, did not similarly activate TAAR4 (FIG. 2C). A panel of other structurally related chemicals and phenylalanine metabolites also did not activate TAAR4 with comparable affinity (FIG. 15). Furthermore, 2-phenylethylamine did not similarly activate other olfactory TAARs with identified ligands (FIG. 2D), although it did activate TAAR1, which is not an olfactory receptor, and at 30-fold higher concentrations TAAR3, which detects many primary amines including benzylamine (FIG. 16). Mass spectrometry, fragmentation analysis, chromatographic retention time (see below), and functional activity all support 2-phenylethylamine being the major natural activator of TAAR4 present in bobcat urine.

### Example 2

### Enriched 2-Phenylethylamine Production by Many Carnivores

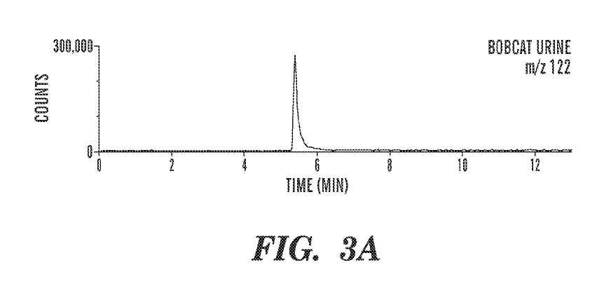

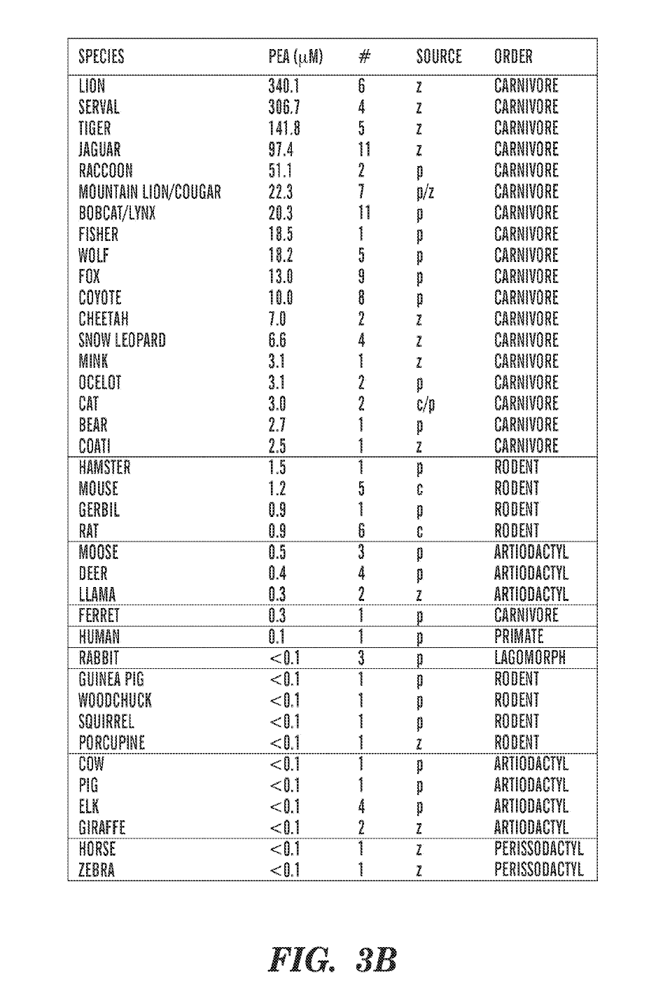

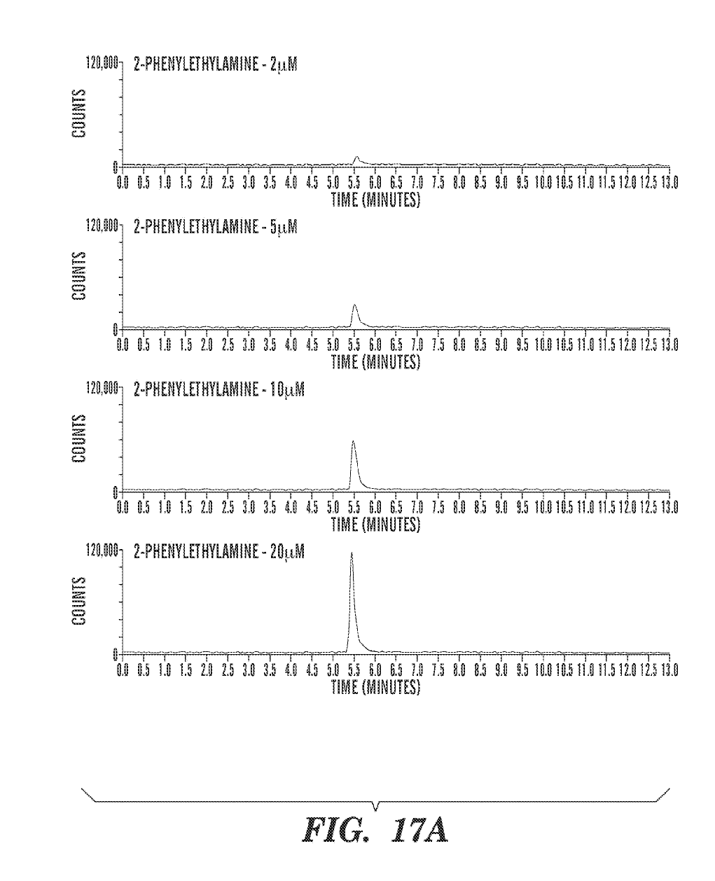

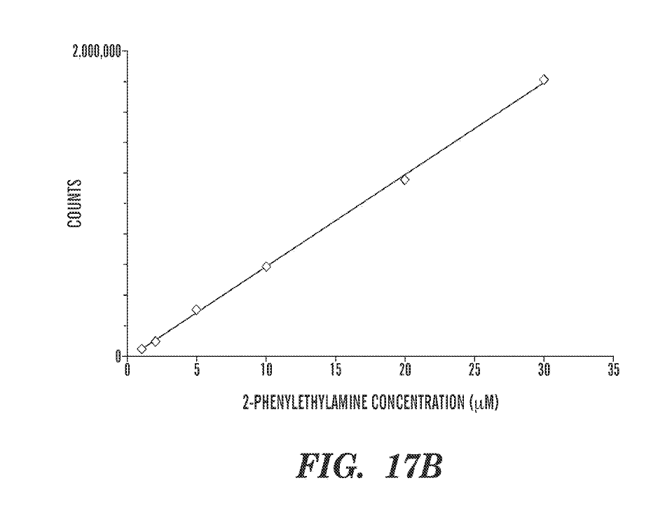

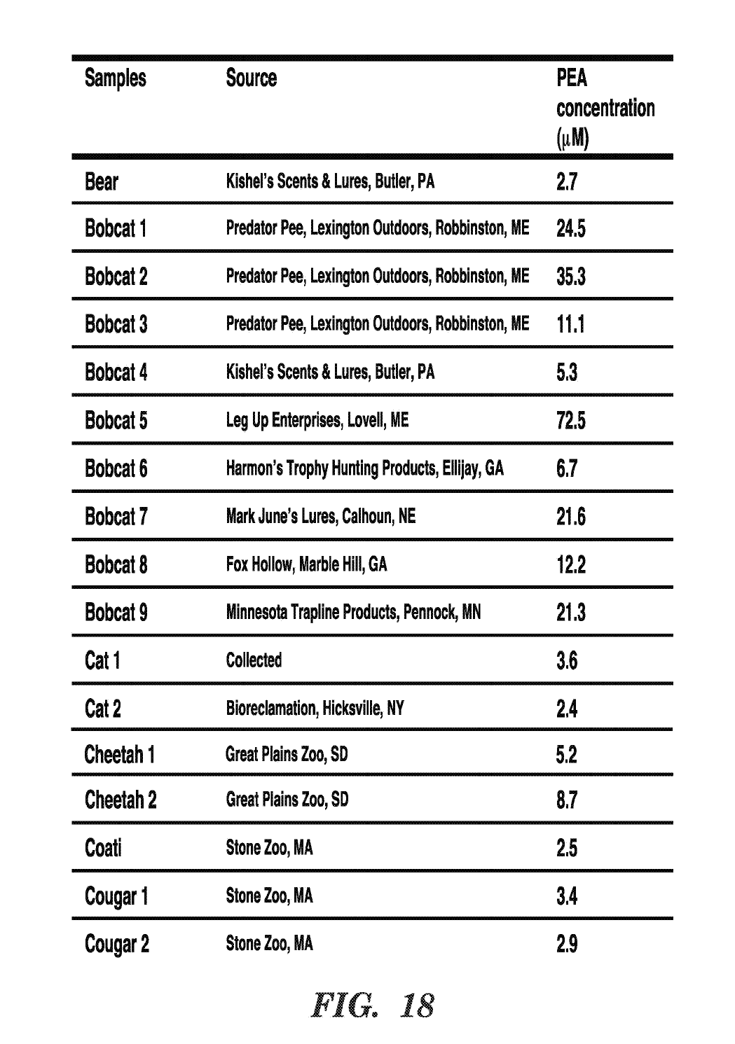

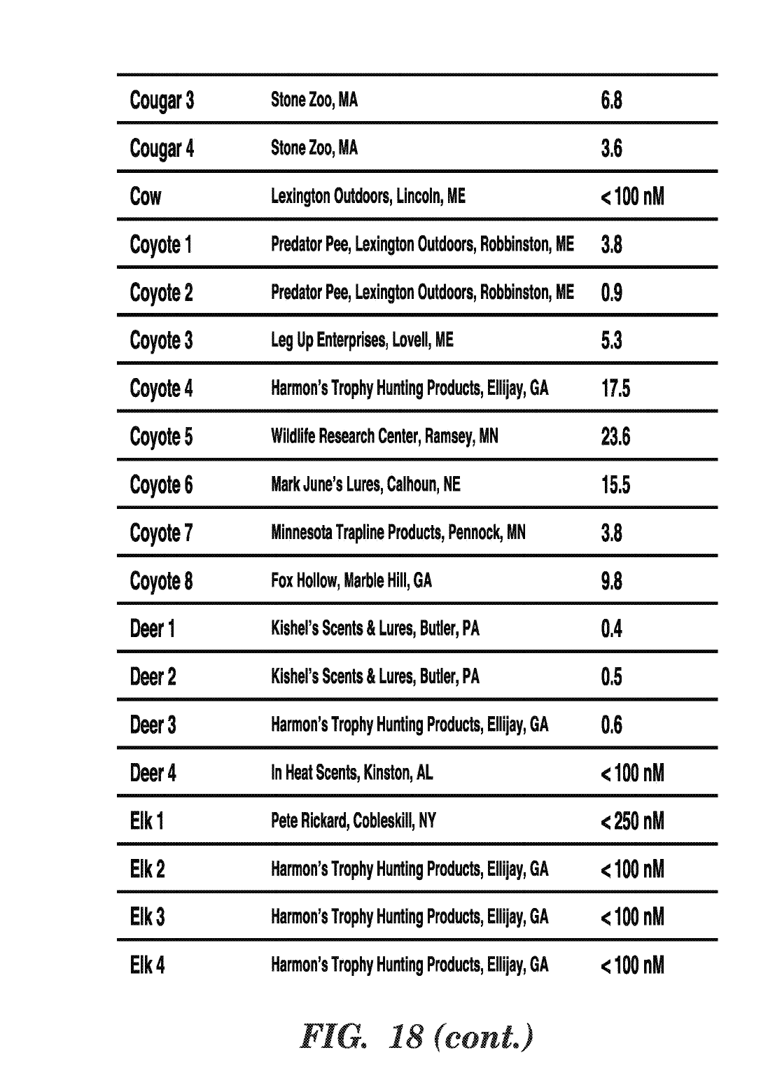

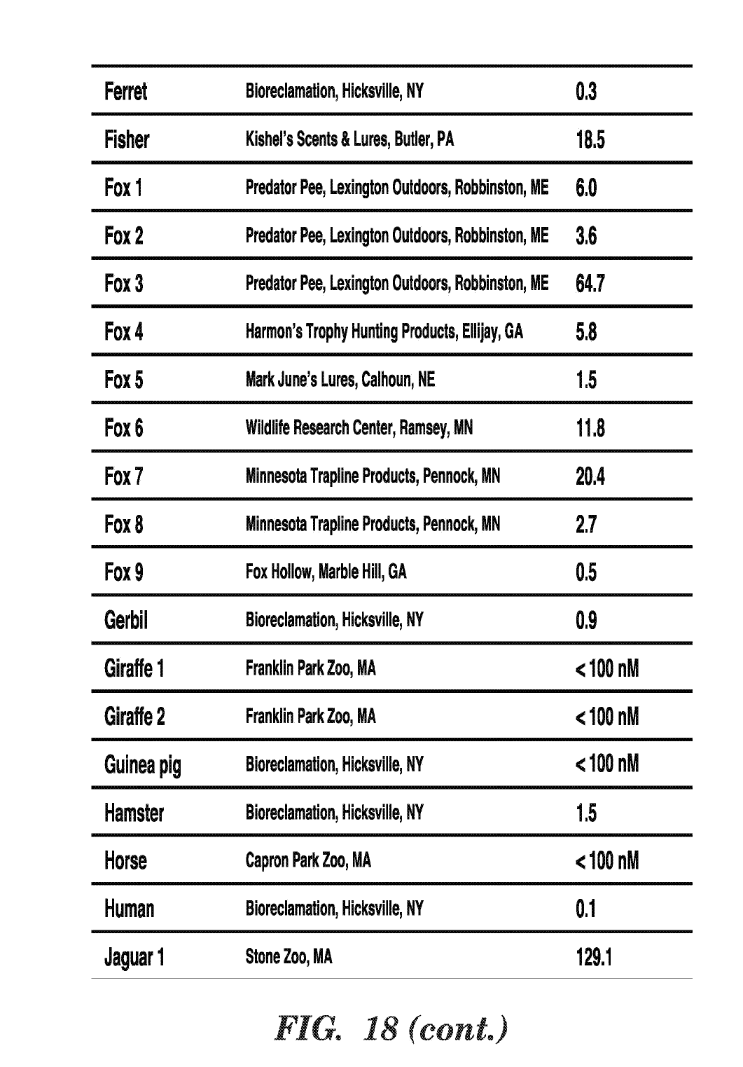

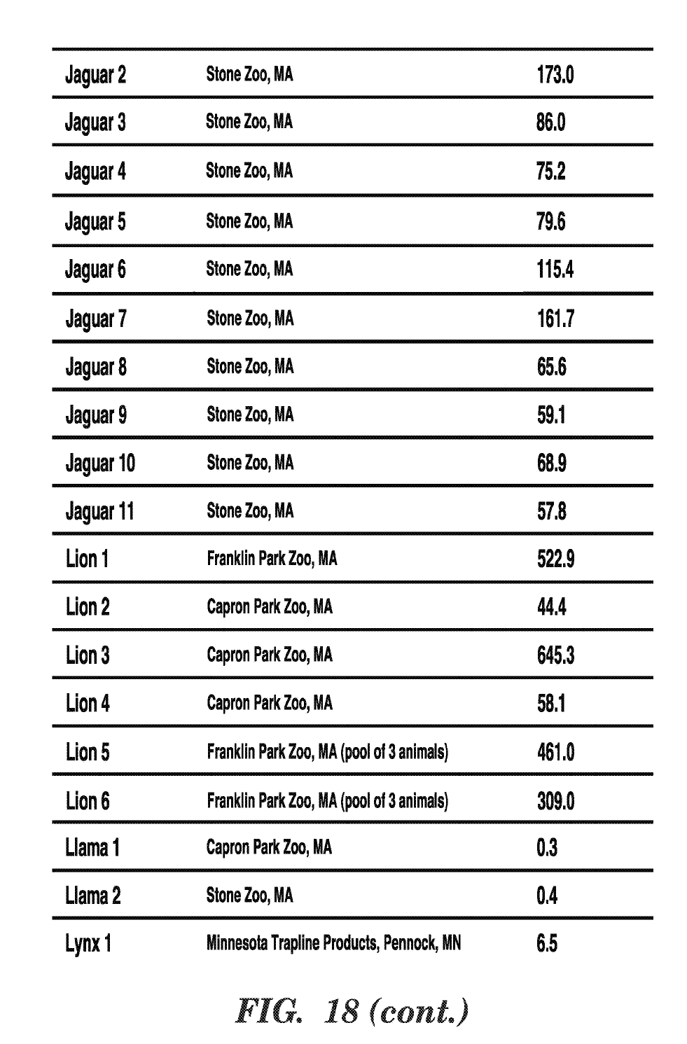

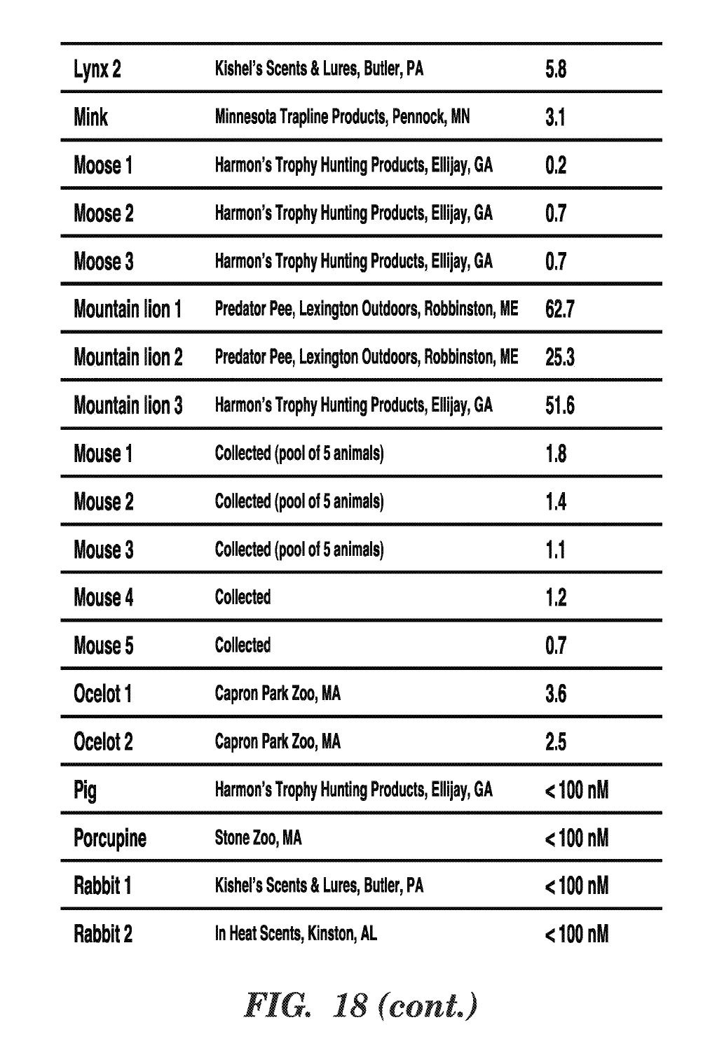

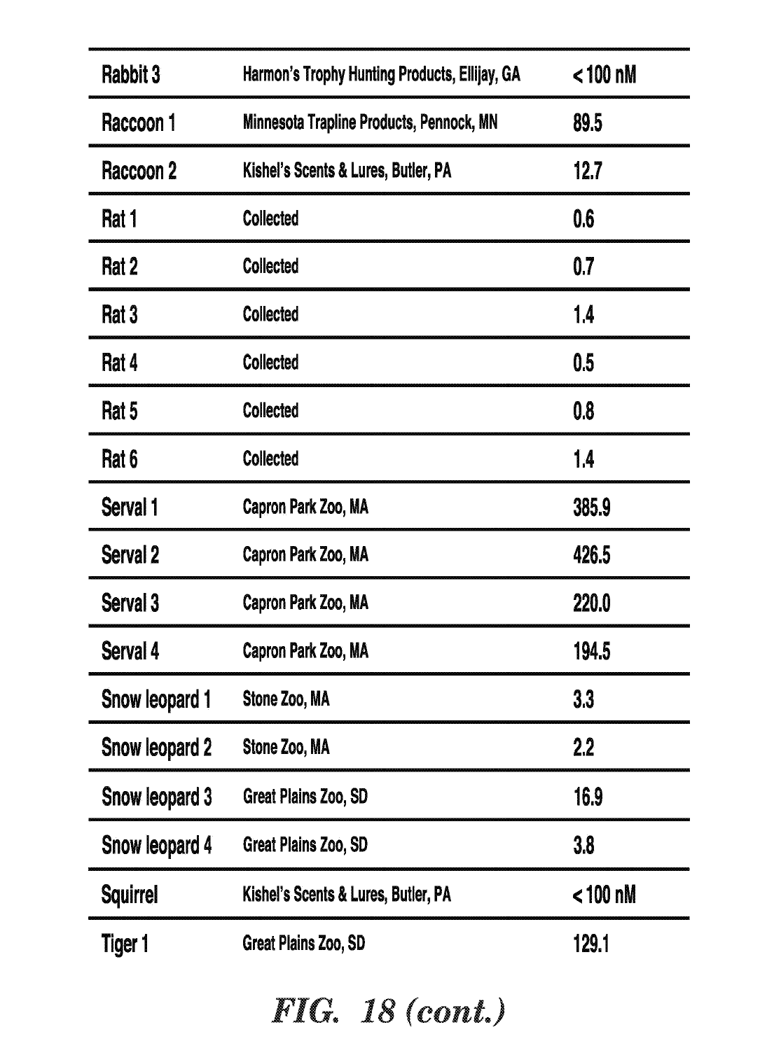

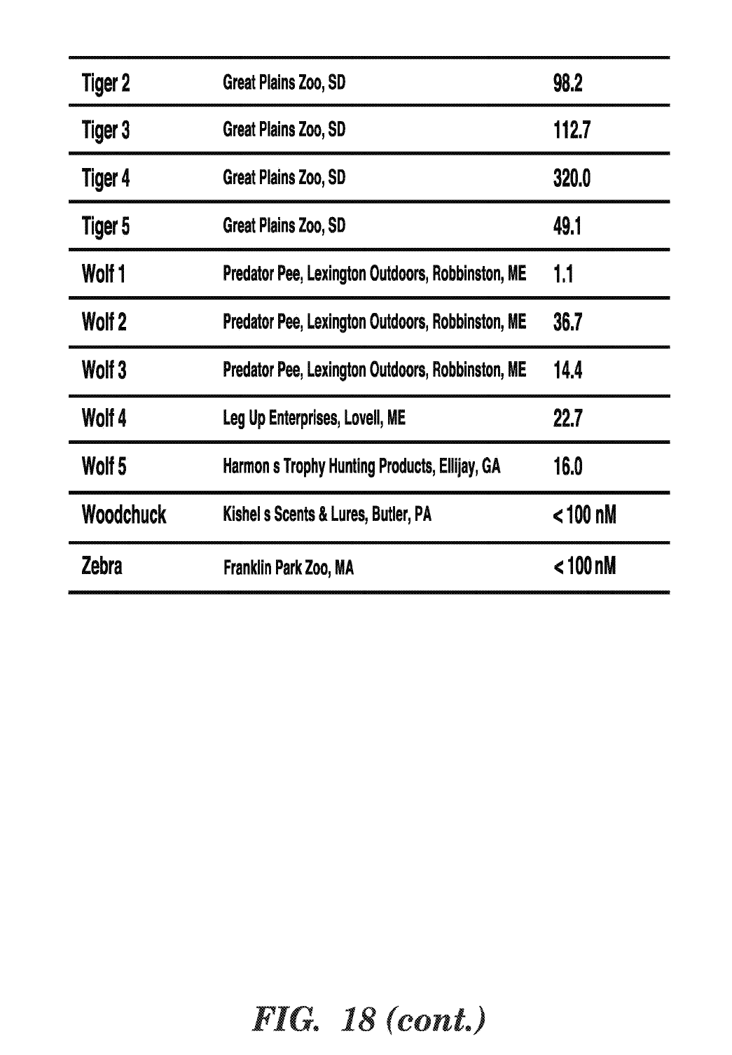

We next examined whether elevated 2-phenylethylamine levels were specific to bobcat urine, or general to many carnivore urines. We used quantitative high performance liquid chromatography coupled with tandem mass spectrometry (LC/MS) to measure concentrations of 2-phenylethylamine in various specimens. Injection of pure 2-phenylethylamine and counting ions of appropriate mass (m/z-122) over time yielded a single peak whose area was linearly correlated with concentration, enabling quantification (FIG. 17). Furthermore, LC/MS analysis of bobcat urine extracts revealed a single peak of ions with m/z=122 that co-migrated precisely with 2-phenylethylamine in spiked samples (FIG. 3A). Next, we quantified 2-phenylethylamine levels in urine extracts of 123 samples from 38 different mammalian species (FIG. 3B), including members of carnivore, rodent, artiodactyl, primate, lagomorph, and perissodactyl orders. Specimens were obtained from multiple collaborating zoos, commercial sources, or overnight collection in a metabolic cage. Zoo specimens were frozen immediately after collection to prevent bacterial growth. In cases where 2-phenylethylamine was not detected in specimen extracts, 20× concentrated extracts were also analyzed for enhanced sensitivity. Urinary 2-phenylethylamine levels varied between species by several orders of magnitude. In 18/19 carnivore urines, 2-phenylethylamine levels were greater than 2 μM, with highest levels observed in lion urine (340.1 μM). In contrast, urine from 0/19 noncarnivore species, representing five different mammalian orders, had 2-phenylethylamine levels above 2 μM. 2-phenylethylamine was undetectable (below 100 nM) in urine from 11/19 of these species. Average 2-phenylethylamine levels in samples from carnivore species examined (56.2 μM) were >50-500 fold higher (FIG. 3C) than average levels in samples from any other mammalian order (<100 nM to <1 μM). We did observe some variation in 2-phenylethylamine levels between specimens of the same carnivore species (FIG. 18). For example, levels in 11 bobcat specimens ranged from 5.3 μM to 72.6 μM, indicating that its production can be further influenced by unknown physiological factors. However, levels of 2-phenylethylamine were higher in all 11 bobcat specimens than in any of 40 non-carnivore samples tested. Together, these data indicate that 2-phenylethylamine is a common metabolite whose production is elevated in many carnivores.

### Example 3

### 2-Phenylethylamine Activates Mouse Olfactory Sensory Neurons

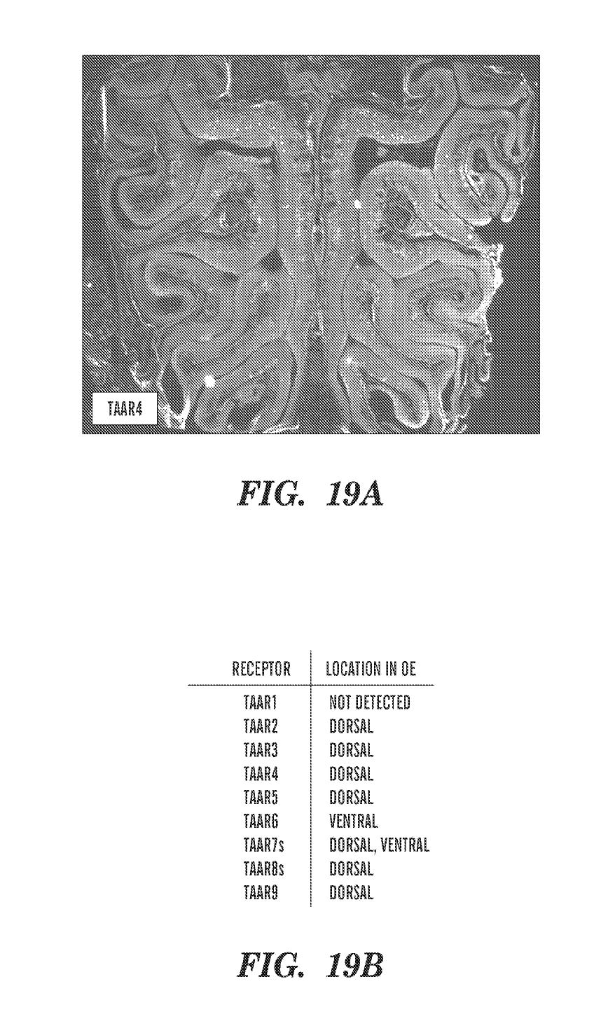

The mammalian olfactory system encodes odor identity using combinations of olfactory receptors (11). Population imaging of sensory neurons in tissue slices has provided a valuable strategy for understanding how the olfactory system recognizes pheromones, MHC peptides, and complex scent cues containing information about gender and individuality (12-15). Here, we used a confocal imaging strategy to record cytosolic calcium transients of single sensory neurons in real time. Viability of analyzed neurons was determined after odor exposures by KCl-induced depolarization. 2-phenylethylamine activated a subset of KCl-responsive olfactory sensory neurons located in both the dorsal and ventral olfactory epithelium, although a higher percentage of responsive neurons were located dorsally (FIG. 4A, 4B). The number of responding neurons in dorsal olfactory epithelium, which varied with test concentration, indicated that 2-phenylethylamine activated multiple olfactory receptors (FIG. 4C). The percentage of activated neurons was similar to what has been reported for other odors (11, 16). Since the dorsal region of the olfactory epithelium mediates behavioral responses to numerous aversive odors, including a carnivore urine (4), and is also the site of TAAR4 expression (FIG. 19), we focused on imaging dorsal olfactory epithelium in subsequent experiments.

In dorsal olfactory epithelium, we identified a small subset of carnivore odor-selective sensory neurons (21/1268; 1.7%) that were activated by lion but not giraffe urine (diluted 10,000:1). Most, but not all, carnivore odor-selective neurons responded to 2-phenylethylamine (13/21 activated by 10,000:1 lion urine and 10/18 activated by 100:1 lion urine). This indicates 2-phenylethylamine to be a major, but not exclusive, lion urine-enriched cue recognized by the main olfactory system. Furthermore, some 2-phenylethylamine-responsive neurons were effective at distinguishing lion urine and giraffe urine, and did not respond to benzylamine (13/52, 25% of 2-phenylethylamine-responsive neurons; or 13/1268, ˜1% of all dorsal KCl-responsive neurons), while others were activated by all four test stimuli (30/52, FIG. 4D). None of the carnivore odorselective neurons that were activated by 2-phenylethylamine also responded to benzylamine (0/1268). Together, these data indicate that 2-phenylethylamine is detected by the rodent olfactory system, activates multiple olfactory receptors, and is a major part of a lion odor blend recognized by rodents. Importantly, these data demonstrate that olfactory sensory neurons, like vomeronasal neurons shown previously (5, 7), have the capacity for interspecies cue recognition.

### Example 4

### Rodents Avoid a 2-Phenylethylamine Odor Source

We next examined behavioral responses of rodents to 2-phenylethylamine. Rats avoid predator urines in an open field paradigm (17), so we asked whether 2-phenylethylamine elicits a similar reaction. Behaviors of rats in a square-shaped arena were recorded and analyzed following placement of test stimuli in a pseudorandom corner (FIG. 5A). Animals did not display spatial preference for any corner following exposure to water, while animals actively avoided corners containing lion and coyote urine. A significant avoidance response was also observed to corners containing 2-phenylethylamine (FIG. 5B, 5C), in a dose-dependent manner (FIG. 5D), but not benzylamine, a highly related amine with similar physical properties. The percentage of time rats are located in the odor quadrant during a ten minute exposure to various test stimuli was measured to be 26.7±6.8% for water, 5.2±1.4% for lion urine, 4.6±1.1% for coyote urine, 29±7.2% for benzylamine, and 8.0±2.0% for 2-phenylethylamine (FIG. 5C, 12 animals±SEM). Thus, 2-phenylethylamine, in the absence of other predator odor cues, was sufficient to evoke rat avoidance behavior.

Avoidance to 2-phenylethylamine in rats was associated with acute changes in circulating levels of the stress hormone corticosterone. Using a competitive radioactive binding assay, plasma levels of corticosterone were measured (FIG. 5E) following exposure to water (103±16 ng/ml, n=16), TMT (238±21 ng/ml, n=16), 2-phenylethylamine (194±18 ng/ml, n=20) and benzylamine (130±32 ng/ml, n=8). Increases in plasma corticosterone levels following exposure to TMT or 2-phenylethylamine, but not benzylamine, were statistically significant compared to exposures involving water. Thus, 2-phenylethylamine activates olfactory circuits that provide input to the hypothalamicpituitary-adrenal axis that orchestrates systemic stress responses.

To test generality across rodent species, we assessed behavioral responses of mice to 2-phenylethylamine. Valence responses to odors were measured using a modified version of a two-choice compartment assay that was previously established for mouse aversion behavior (4). Male mice were exposed to aerosolized stimuli delivered to a test compartment in an otherwise odor-free arena. Time spent in the odor compartment was measured before and during odor delivery, and the odor-evoked change in occupancy recorded (FIG. 5F). Female urine, a powerful attractant for male mice, increased test compartment occupancy (+102±34.2%, n=6), while water alone had no effect (−4.0±9.2%, n=6). In contrast, TMT (−58.9±11.2%, n=7) and 2-phenylethylamine (−51.3±10.0%, n=7) decreased test compartment occupancy. Mice lacking TrpC2 displayed similar innate avoidance responses to 2-phenylethylamine (−42.0±14.0%, n=5), indicating that signaling through the vomeronasal organ is not required. These data indicate that 2-phenylethylamine is aversive to mice, as well as rats, and that response patterns are conserved in at least two rodent species.

### Example 5

### 2-Phenylethylamine is Required for Aversion Responses to Lion Urine

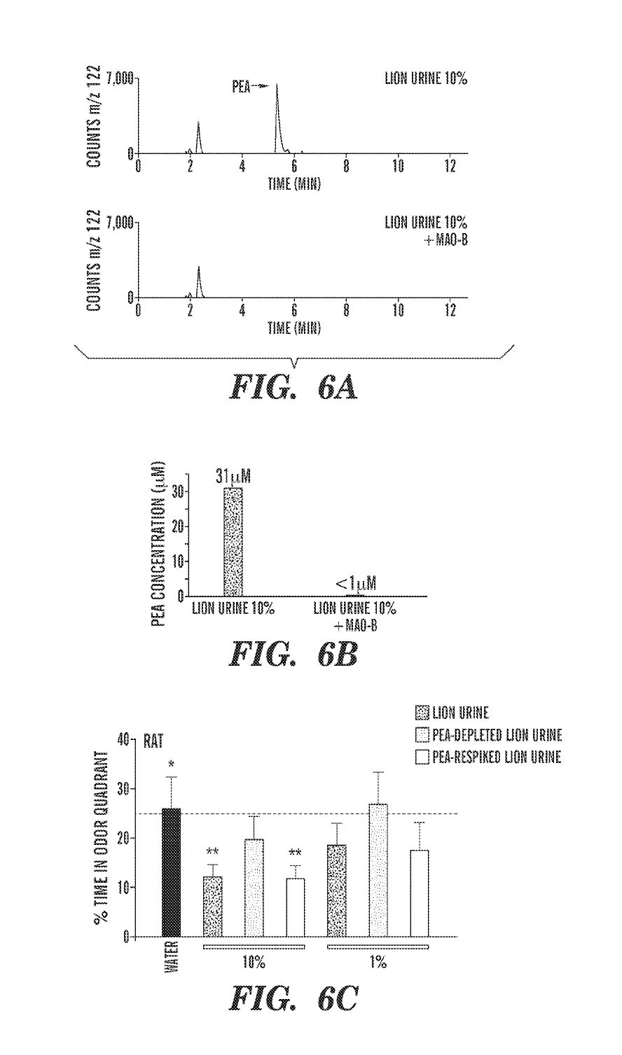

We next asked whether 2-phenylethylamine was required for lion urine-evoked avoidance responses in the rat. To address this, we developed a method of depleting 2-phenylethylamine from lion urine. Lion urine (Specimen 6, FIG. 18, 309 μM 2-phenylethylamine) was diluted ten-fold and treated with monoamine oxidase B (MAO-B), an enzyme that oxidizes certain aromatic amines with preferred substrate preference for 2-phenylethylamine and dopamine (18). After addition of MAO-B to 10% lion urine, 2-phenylethylamine was undetectable by quantitative HPLC, with a detection limit of 1 μM (FIG. 6A, 6B). Since MAO-B could potentially oxidize other biogenic amines present in lion urine, we created a third test specimen “PEA-respiked lion urine” in which 2-phenylethylamine was reintroduced to original, physiological levels following MAO-B inhibition.

Rat avoidance responses were measured to dilutions of (1) lion urine, (2) “PEA-depleted lion urine” (lion urine treated with MAO-B), and (3) “PEA-respiked lion urine” (FIG. 6C). Rats showed significant avoidance behavior to 10% lion urine, but not to 10% “PEA-depleted lion urine”. Furthermore, full aversion was restored to 10% “PEA-respiked lion urine”, indicating that 2-phenylethylamine is indeed the relevant MAO-B substrate required for the full avoidance response to lion urine. Other potential MAO-B substrates, if present, are not important for avoidance behavior since rat responses are identical to 10% lion urine and 10% “PEA-respiked lion urine” despite different levels of such substrates. Furthermore, based on this analysis, 2-phenylethylamine evokes avoidance behavior at physiological concentrations in the context of other lion-derived odor cues. Together, our data provide evidence that 2-phenylethylamine is a key component of a carnivore odor blend detected and avoided by rodents.

### Example 6

### Agonists for 13 Trace Amine-Associated Receptors (TAARs) Provide Insight into the Molecular Basis of Odor Selectivity

Trace amine-associated receptors (TAARs) are vertebrate olfactory receptors. However, ligand recognition properties of TAARs remain poorly understood, as most are ‘orphan receptors’ without known agonists. Here, we identify the first ligands for several rodent TAARs, and classify these receptors into two subfamilies based on phylogeny and binding preference for primary or tertiary amines. Mouse and rat orthologs have similar response profiles, although independent Taar7 gene expansions led to highly related receptors with altered ligand specificities. Using chimeric TAAR7 receptors, we identified an odor contact site in transmembrane 3 that functions as a selectivity filter. Molecular modeling studies based on X-ray crystal structures of related G Protein-Coupled Receptors (GPCRs) indicate close proximity of this site to the ligand. Gain-of-function mutations at this site created olfactory receptors with radically altered odor recognition properties. These studies provide new TAAR ligands, valuable tools to study receptor function, and general insights into the molecular pharmacology of GPCRs.

The initial event in mammalian olfaction is the detection of odor molecules by chemosensory G Protein-Coupled Receptors (GPCRs). Olfactory sensory neurons, in particular, use two families of GPCRs, Odorant Receptors (ORs) and Trace Amine-Associated Receptors (TAARs), to effectively convert chemical signals from the environment into electrical signals that are transmitted to the brain (25, 26).

The olfactory system uses a combinatorial coding scheme, in which each receptor detects multiple odors and each odor activates multiple receptors (27). Consistent with this scheme, many olfactory receptors are broadly tuned to detect a large number of structurally related chemicals (28, 29), although some are narrowly tuned for particular odors (30). While many OR agonists have now been identified (28, 29, 31, 32), our current understanding of the ligand specificity among olfactory receptors is based on studies involving only a small number of ORs (29, 33-35). The odor binding pocket in these ORs is composed of highly variable amino acid side chains in transmembrane (TM) segments 3, 5, and 6.

In contrast, the structural basis for odorant recognition by TAARs remains uncharacterized, mainly due to a lack of identified agonists. The TAARs are an evolutionarily conserved family of receptors found in diverse vertebrates, including 15 in mouse (mTAARs), 17 in rats (rTAARs), 6 in human, and 112 in zebrafish (36-38). TAARs do not share sequence similarity with ORs but instead are distantly related to biogenic amine receptors, a medically important class of GPCRs (36, 37). In mammals, most TAARs retain conserved motifs of biogenic amine receptors critical for ligand recognition (36, 39), including an aspartic acid in TM3 that forms a salt bridge with the ligand amino group. These observations indicated that rodent TAARs would be amine receptors, but ligands remained largely unknown.

We previously identified the first ligands for mouse TAAR3, TAAR4, TAAR5, and TAAR7f, and each indeed detects a different combination of volatile amines (40). In addition, ligands were reported for TAAR1, which is not an olfactory receptor, and rTAAR4 (then called TA-2) (40, 41). Moreover, these TAAR agonists include biogenic amines secreted into urine, a rich source of chemosignals for rodents (40, 42, 43). A TAAR4 agonist, 2-phenylethylamine, is a carnivore odor that repels rodents (42), and a TAAR5 agonist, trimethylamine, is a sexually dimorphic mouse odor (40). The biosynthesis of these naturally occurring TAAR ligands can be dynamic, varying with age, sex, or physiological state (40, 43). Furthermore, some TAAR ligands trigger innate behavioral responses in mice (42, 44).

Here, we set out to identify agonists for additional mouse and rat TAARs. We examined odor response profiles using a previously established reporter gene assay based on cAMP-dependent odor transduction in olfactory sensory neurons (40, 42). Briefly, TAAR plasmids were transfected into HEK293 cells along with a cAMP-dependent reporter gene encoding secreted alkaline phosphatase (CRE-SEAP). TAARs were expressed both in unmodified form and as fusion proteins with an N-terminal sequence of bovine rhodopsin (‘Rho tag’) that promotes cell surface expression of some chemosensory receptors (35). Transfected cells were incubated with test chemicals, and phosphatase activity was quantified with a fluorescent substrate as a reporter for TAAR activation. In initial experiments, we tested 38 different odorant mixtures containing 244 structurally diverse test chemicals (2-5 μM) for the ability to activate each mTAAR. Subsequently, we tested 73 amines that included known mTAAR agonists and related chemicals for the ability to activate each rTAAR.

Using this strategy, we identified ligands for nine additional olfactory TAARs that were previously orphan receptors (FIG. 7), including mTAAR7b, mTAAR7e, rTAAR3, rTAAR5, rTAAR7b, rTAAR7d, rTAAR7h, rTAAR8c, and rTAAR9. The first ligands for mTAAR7b and mTAAR7e were identified in previous unpublished work (SDL and Linda B. Buck). Responding TAARs were functional with or without a ‘Rho tag’ except for mTAAR4 and rTAAR5, which required a ‘Rho tag’, and mTAAR3 and rTAAR7b which did not work with a ‘Rho tag’. Each of these nine TAARs was activated by volatile amines, and ligand preferences were generally similar between mouse and rat orthologs. Amines that activated mTAAR3, mTAAR4, and rTAAR3 were primary amines that could be derived from natural amino acids by a single decarboxylation reaction. In contrast, ten other TAARs were activated by tertiary amines, including several N,N-dimethylated amines. Identified ligands elicited half maximal TAAR responses at concentrations (EC₅₀) that ranged from 100 nM to 30 μM (FIG. 11), comparable to the agonist sensitivity of odorant receptors in similar assays (32, 34). Interestingly, several TAAR ligands were natural products secreted by animals, including various amino acid derivatives and the serotonin metabolite 5-methoxy-N,N-dimethyltryptamine whose production patterns in urine are dynamic and vary with physiological state (45, 46).

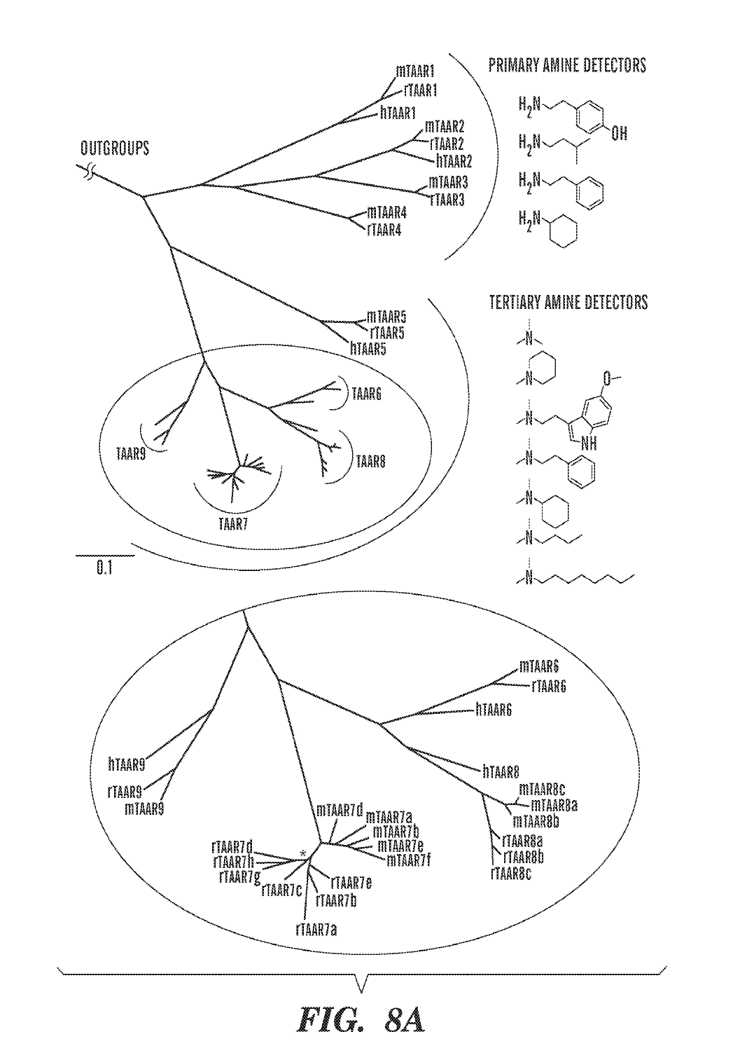

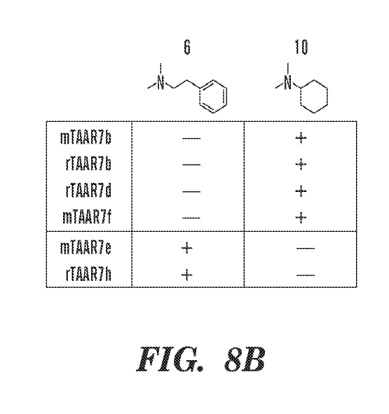

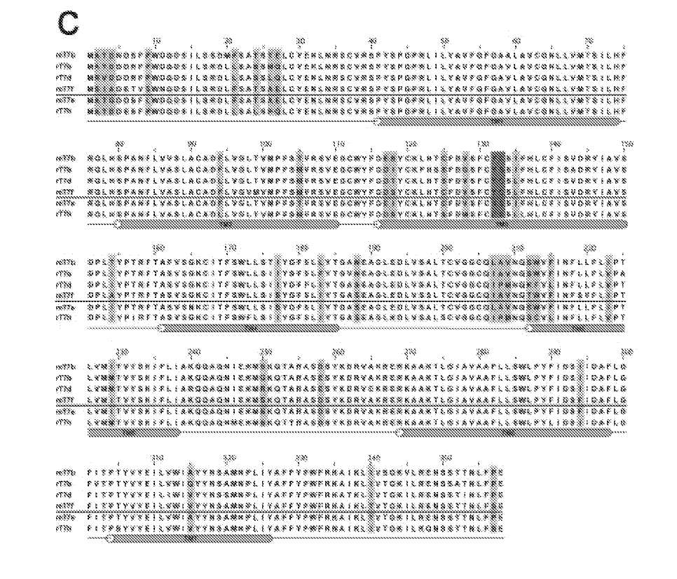

We noted that TAARs could be clustered into two groups based on whether they detected primary or tertiary amines. Interestingly, these two groups mapped to distinct branches of the TAAR phylogenetic tree (FIG. 8a). This phylogeny was constructed by Bayesian analysis of all TAAR nucleotide sequences in the mouse, human, and rat genomes. Unlike vomeronasal receptors, which are rapidly evolving (47), TAAR orthologs are highly conserved in sequence and gene number between species, as well as in ligand binding preference. Exceptions are lineage-specific expansions of the TAAR7 and TAAR8 sub-families, which occurred independently in mouse and rat. Our analysis indicates that the last common ancestor of rat and mouse likely had one TAAR8 and one TAAR7.

The rapid expansion of the TAAR7 subfamily led to the evolution of highly related olfactory receptors with distinct response profiles. Based on this observation, we reasoned that the TAAR7 subfamily could provide a unique opportunity to study how evolutionary changes in receptor sequence drive changes in odor binding preference.

We identified three amines, 6 (N,N-dimethylcyclohexylamine), 7 (5-methoxy-N,N-dimethyltryptamine), and 10 (N,N-dimethylphenylethylamine) that activated different TAAR7 paralogs in mouse and rat. Two receptors (mTAAR7e and rTAAR7h) were activated by 6 but not 10, while four receptors (mTAAR7b, mTAAR7f, rTAAR7b, and rTAAR7d) were activated by 10 but not 6. We aligned the sequences of responding TAAR7s to identify amino acid variations that correlated with differences in odor responses (FIG. 8b). These sequences were highly related (>87% identical), and most amino acids were conserved (found in >5/6 analyzed sequences). Of the few amino acid variations identified, only residues 132^{3.37} and 133^{3.38} varied in accordance with ligand response profile (superscripts indicate the TM number and relative TM position of particular residues, as defined by the Ballesteros & Weinstein indexing method (39)). Interestingly, these two residues are immediately adjacent on TM3, and in proximity to Asp127^{3.32}, the conserved amine-contact site of biogenic amine receptors (39). Furthermore, a key odor contact site of a eugenol-detecting OR, Ser113^{3.40}, occupies a similar position in TM3 (34). Based on these observations, we reasoned that amino acid variations at positions 132^{3.37} and 133^{3.38} could contribute to selective TAAR responses.

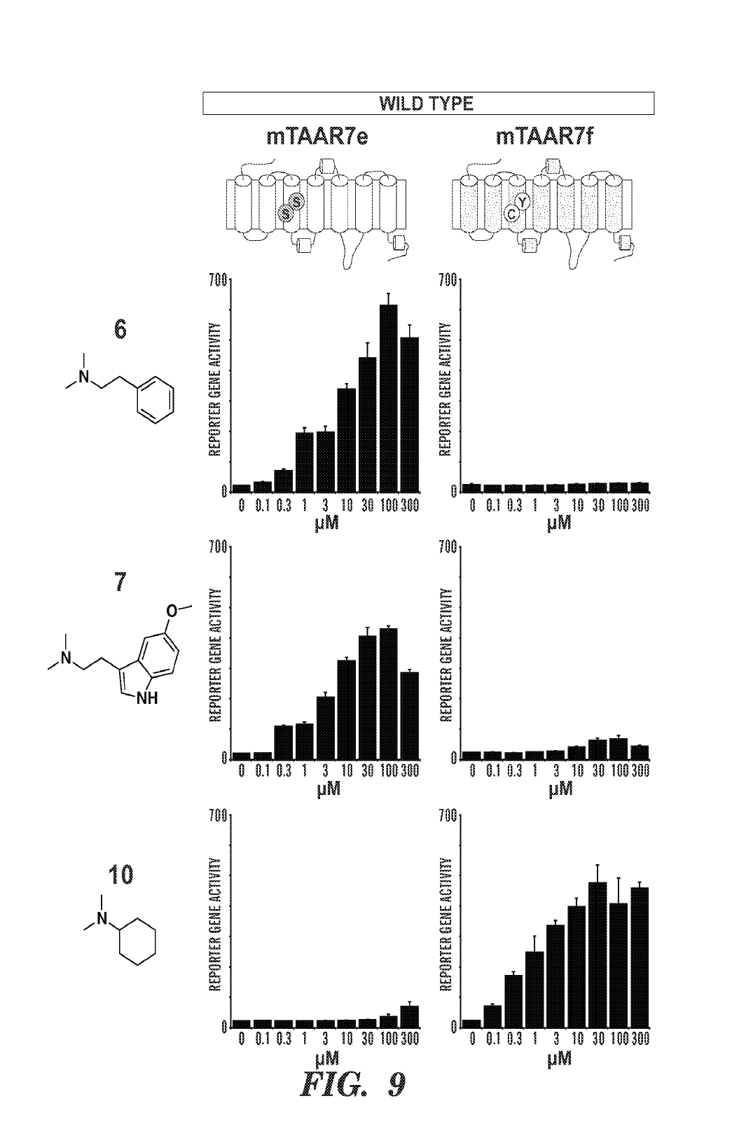

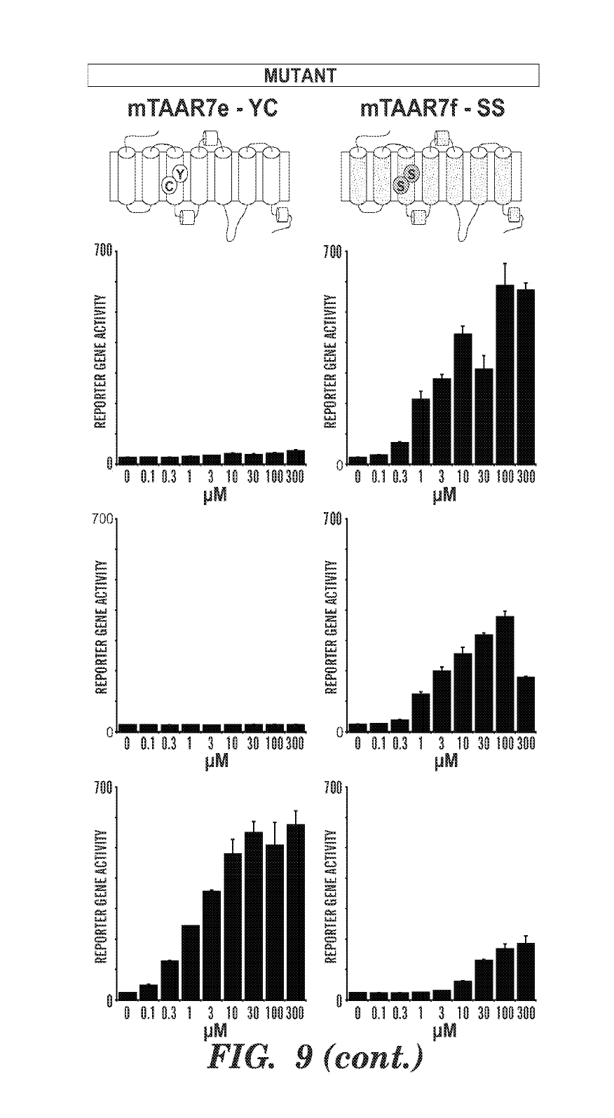

To test this, we created mutant receptors in which sequences of mTAAR7e were swapped into mTAAR7f and vice versa. Position 132^{3.37} is a tyrosine in mTAAR7f and the other three receptors that detect 10, but a serine in mTAAR7e and a cysteine in rTAAR7h, the two receptors that detect 6. Furthermore, position 133^{3.38} is a cysteine in mTAAR7f but a serine in mTAAR7e and rTAAR7h. We altered positions 132^{3.37} and 133^{3.38} by mutation of mTAAR7e (‘mTAAR7e-YC’) and mTAAR7f (‘mTAAR7f-SS’) and examined odor responses of these mutants using the cellular reporter gene assay (FIG. 9).

Interestingly, this single modification caused a dramatic reversal in odor responsiveness (FIG. 8). mTAAR7e-YC had the same ligand selectivity profile as mTAAR7f rather than mTAAR7e. These effects were striking, as mTAAR7e-YC had >1,000-fold enhanced affinity for 10 and >1,000-fold decreased affinity for 6 or 7. Furthermore, the reciprocal mutant, mTAAR7f-SS, had mTAAR7e-like responses. mTAAR7f-SS displayed >1,000-fold increases in affinity for both ligands 6 and 7 and ˜100-fold reduced affinity for ligand 10. These data provide strong evidence that residues 132^{3.37} and 133^{3.38} are part of the TAAR ligand binding pocket and form an important selectivity filter that imparts selective odor responses.

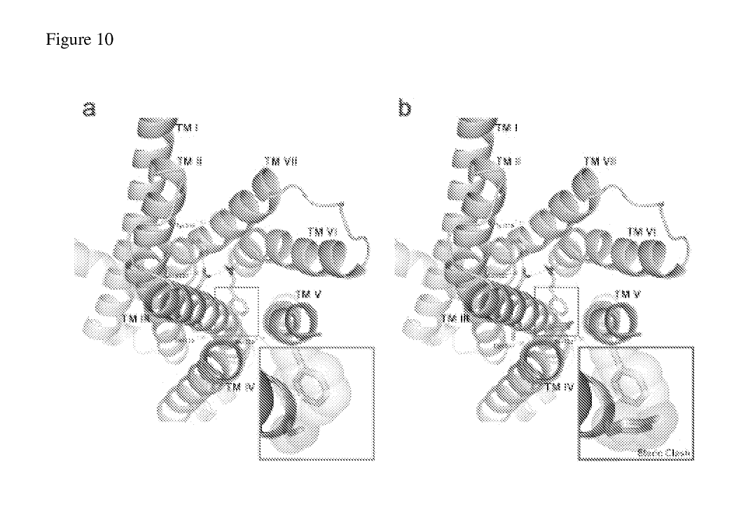

To gain additional insights into the structure of the odor-binding pocket in TAARs, we created homology models of mTAAR7e and mTAAR7f (FIG. 10). We based our model on X-ray crystal structures of the human 132 adrenergic receptor (β₂AR, PDB ID: 3P0G) (48), which is 25% identical to mTAAR7e and mTAAR7f, binds similar amine ligands, and aligns without gaps in 6 out of 7 TM regions. Based on these models, mTAAR7e and mTAAR7f have the canonical bundle of 7 α-helices and the intracellular helix VIII that runs parallel to the membrane axis. In addition, we observed other conserved motifs of class A GPCRs (25), such as a disulfide bridge between extracellular loop (ECL) 2 and the extracellular end of helix III (Cys205 and Cys120^{3.25}), as well as the D/ERY sequence of the “ionic lock” motif at the cytoplasmic end of helix III (25). Surprisingly, we also observed a short α-helix in ECL2 (Glu193-Thr200) in mTAAR7e and mTAAR7f, a motif that is not common among most GPCRs, but is present in β₁AR and β₂AR (25).

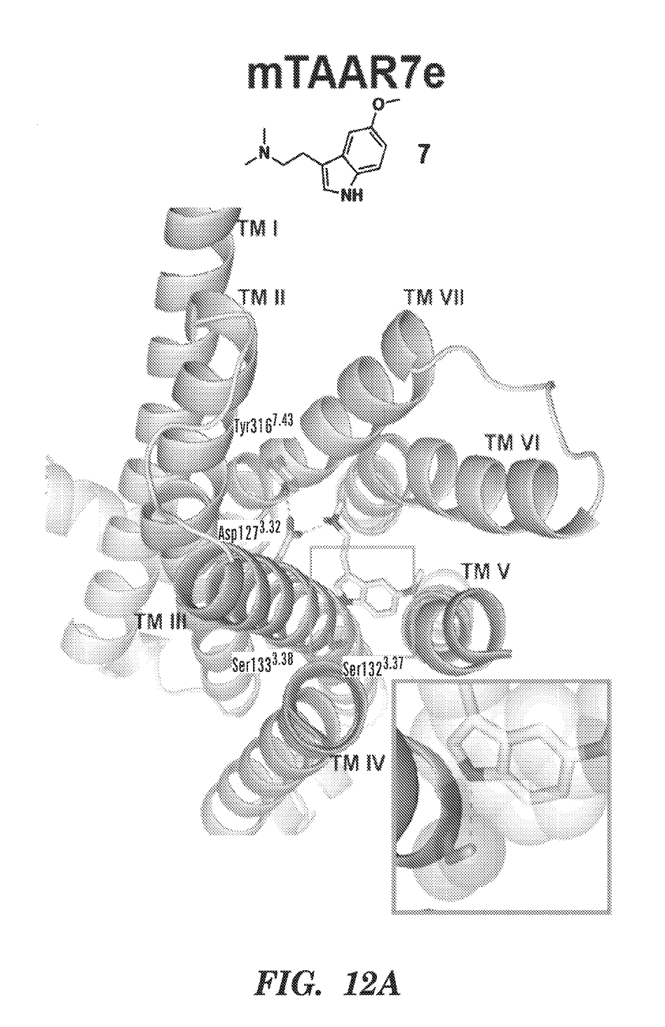

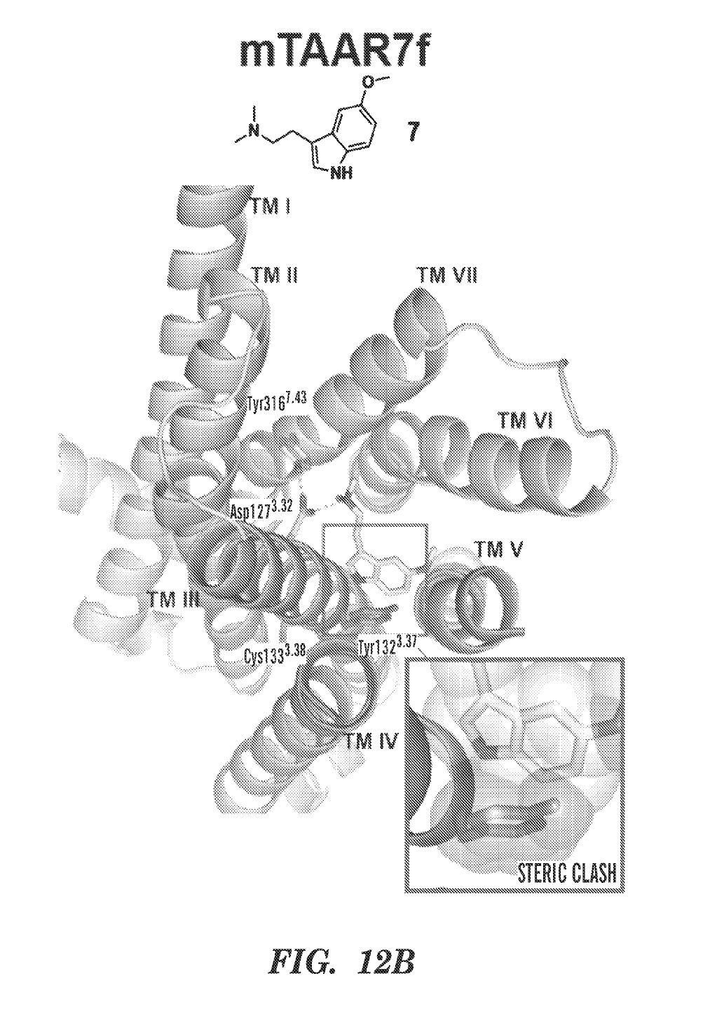

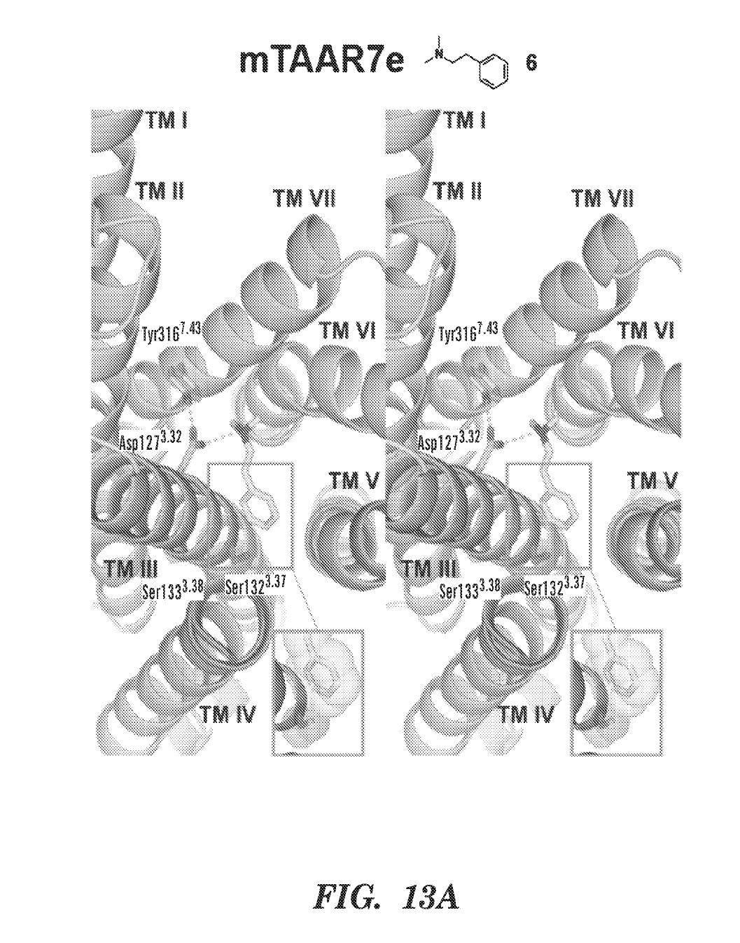

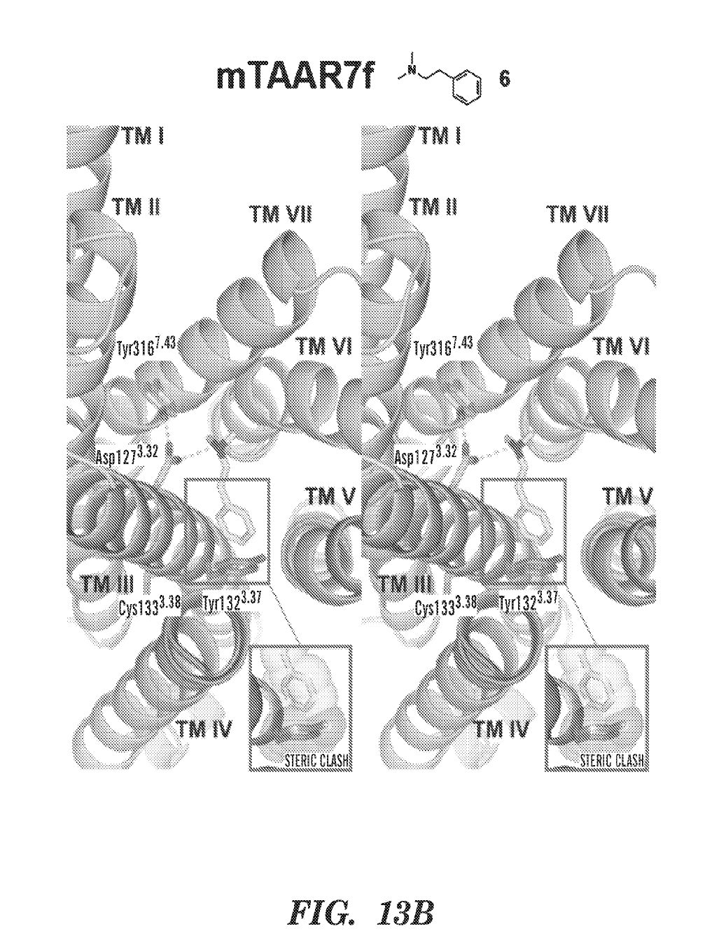

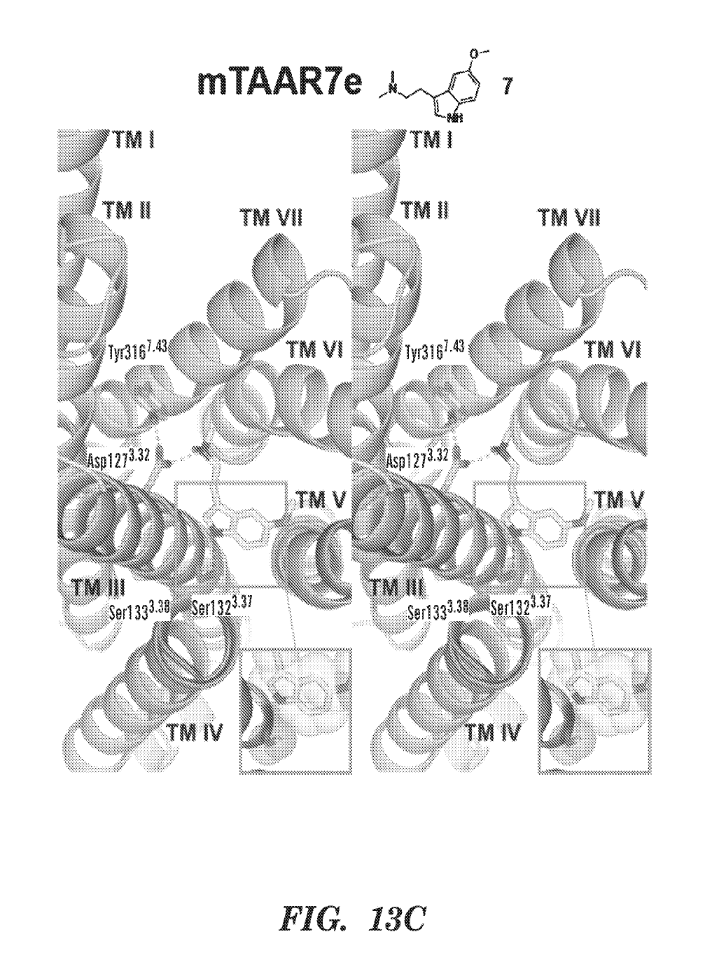

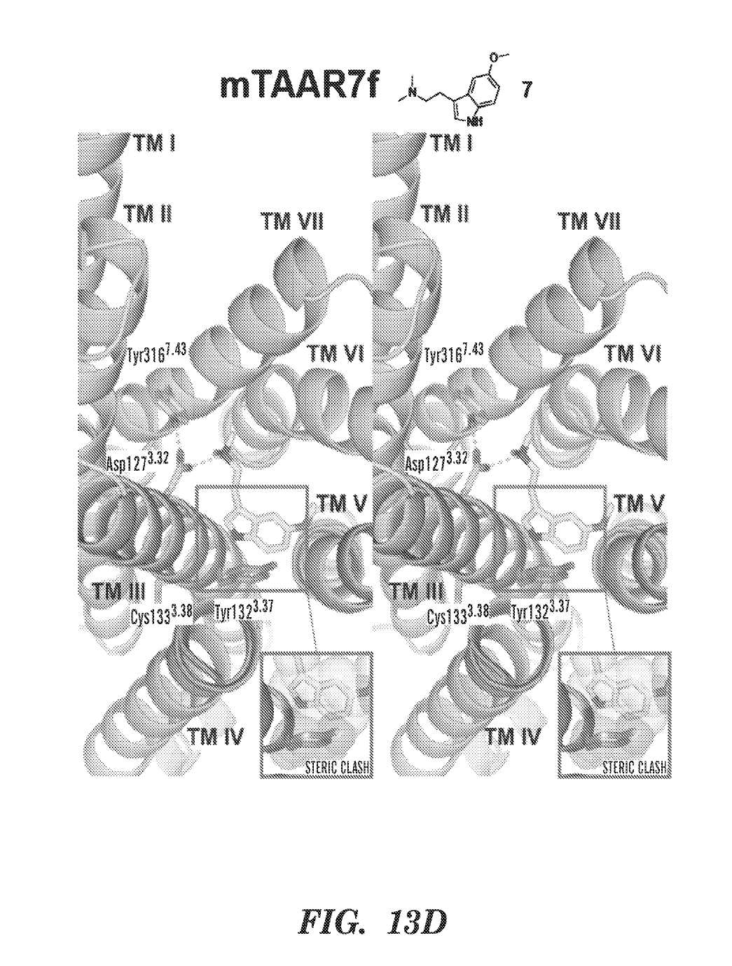

Next, we examined the putative ligand contact sites in the structural models of mTAAR7e and mTAAR7f. Our models suggest that the ligand amino group forms a salt bridge with Asp127^{3.32}, which itself is anchored by a hydrogen bond to the hydroxyl group of Tyr316^{7.43} (FIG. 10). Asp127^{3.32} is conserved among many GPCRs and a similar salt bridge between receptor and ligand was also found in crystal structures of β₁AR, β₂AR, and the H1 histamine receptor (49, 50). The model shows that Tyr132^{3.37} of mTAAR7f extends into the ligand binding pocket where it sterically blocks both ligands 6 and 7 (FIG. 10 and FIG. 12). In contrast, Ser132^{3.37} of mTAAR7e does not sterically interfere with ligand 6 and can even stabilize ligand 7 through formation of a hydrogen bond between the hydroxyl group of its sidechain and the pyrrole nitrogen of the aromatic ligand moiety (FIG. 10 and FIG. 12). We did not detect any additional amino acid variations in or near the odor binding pockets of mTAAR7e and mTAAR7f, other than positions 132^{3.37} and 133^{3.38}. Based on this, and the dramatic functional change caused by mutation of these residues (FIG. 9), we conclude that these two residues are critical determinants of ligand selectivity differences between these two receptors.

Here, we show how neofunctionalization of the TAAR7 family occurred during evolution by gene duplication and subsequent mutation. The olfactory system uses such evolutionary mechanisms to generate large repertoires of sensory receptors with divergent recognition properties, and these mechanisms are enabled by the inherent flexibility of olfactory system development. Minimal requirements for incorporation of a new GPCR into olfactory circuits include i) obtaining proper gene regulation, and ii) coupling to the correct G protein. For this reason, sensory neurons expressing foreign GPCRs, such as the β-adrenergic receptor (51), can be readily incorporated into the system and can couple to unique neural circuits in the brain. Also for this reason, gene duplication events followed by subsequent mutation of one duplicate is a powerful mechanism to achieve receptor diversity (52). Here, we observe recent expansion of the TAAR7 family in rodents, and subsequent incorporation of specific mutations that alter odor responses. Through this process, evolutionary mechanisms have sculpted the TAAR7 subfamily, leading to rapid and functional expansion of the olfactory receptor repertoire.

### Methods for Example 6

Chemicals. TAAR ligands were purchased from Sigma/Aldrich, unless otherwise indicated.

TAAR functional assays. Full Taar coding regions were cloned into pcDNA3.1-(Invitrogen) with or without a 5′ DNA extension of 69 bp encoding the first 20 amino acids of bovine rhodopsin followed by a cloning linker (GCGGCCGCC). Point mutations were introduced in mTAAR7e and mTAAR7f by overlap extension PCR. Functional assays were performed as described (40, 42). Fluorescence was measured on an EnVision plate reader (Perkin Elmer) and SEAP activity graphed as relative fluorescence of a phosphatase substrate.

Phylogenetic analysis. Full-length Taar coding sequences, and a mouse olfactory receptor sequence (MOR-1362) used as an outgroup, were obtained from NCBI and aligned using Multiple Alignment using Fast Fourier Transform (MAFFT) (53). Alignments of amino acid sequences were performed using ClustalW (54). The model of evolution was estimated in MrMODELTEST (GTR+I+Γ) (55) and the phylogenetic tree was constructed using the program MrBAYES (56) using an exponential distribution with unconstrained values for the branch length. MrBayes was run 10,000,000 generations with 4 Markov chains, and sampling occurred every 1000 generations. The first 1,000,000 trees were discarded as burn-in. Nodal support values were estimated by Bayesian posterior probability.

Generation of mTAAR homology models. 3D models of mTAAR7e and mTAAR7f were generated with the molecular modeling package ICM (Version 3.6.-1b, Molsoft LLC) that uses the ZEGA alignment algorithm (57) and the standard modeling function BuildModel (58). Both models were based on the structure of the nanobody stabilized β₂ adrenergic receptor (β₂AR) bound to the agonist BI-167107 (PDB ID: 3P0G) (48), using only the receptor coordinates. The alignment shows 33% sequence similarity and it was manually adjusted to eliminate minor gaps in TM 1 and the C-terminus. Intracellular loop 3 (ICL3) of both mTAARs was not aligned since the β₂AR construct contains a T4 Lysozyme molecule that replaces ICL3 but is disordered in the structure. A limited energy-based optimization of side chains and loops was done after the coordinates were placed according to the alignment and the 3P0G coordinates. The ligands were placed into the models using COOT (49) and the data was evaluated and figures were made in PyMOL.

### Example 7

Chemicals and specimen collection. Chemicals were purchased from Sigma/Aldrich unless otherwise stated. Amines were purchased as free bases rather than hydrochloride salts. C57BL/6 mouse and Brown Norway rat urines were collected using a metabolic cage, non-identifiable human urine was purchased (Bioreclamation), and other urine samples were obtained from zoos or commercial sources as described in FIG. 18. All animal procedures were in compliance with institutional animal care and use committee guidelines.

TAAR functional assays. Reporter gene assays were performed as described (Liberles S D & Buck LB (2006) A second class of chemosensory receptors in the olfactory epithelium. Nature 442(7103):645-650) with the following minor modifications. Test urines were diluted in serum-free media containing penicillin G (100 Units/ml, Invitrogen) and streptomycin sulfate (100 mg/ml, Invitrogen). SEAP activity is measured as fluorescence resulting from dephosphorylation of a substrate, 4-methylumbelliferyl phosphate. Fluorescence values were obtained using an EnVision plate reader (Perkin Elmer) and are reported directly without normalization. All TAARs, except mouse TAAR3, were expressed as fusion proteins with an N-terminal sequence of bovine rhodopsin (Krautwurst D, Yau K W, & Reed R R (1998) Identification of ligands for olfactory receptors by functional expression of a receptor library. Cell 95(7):917-926).

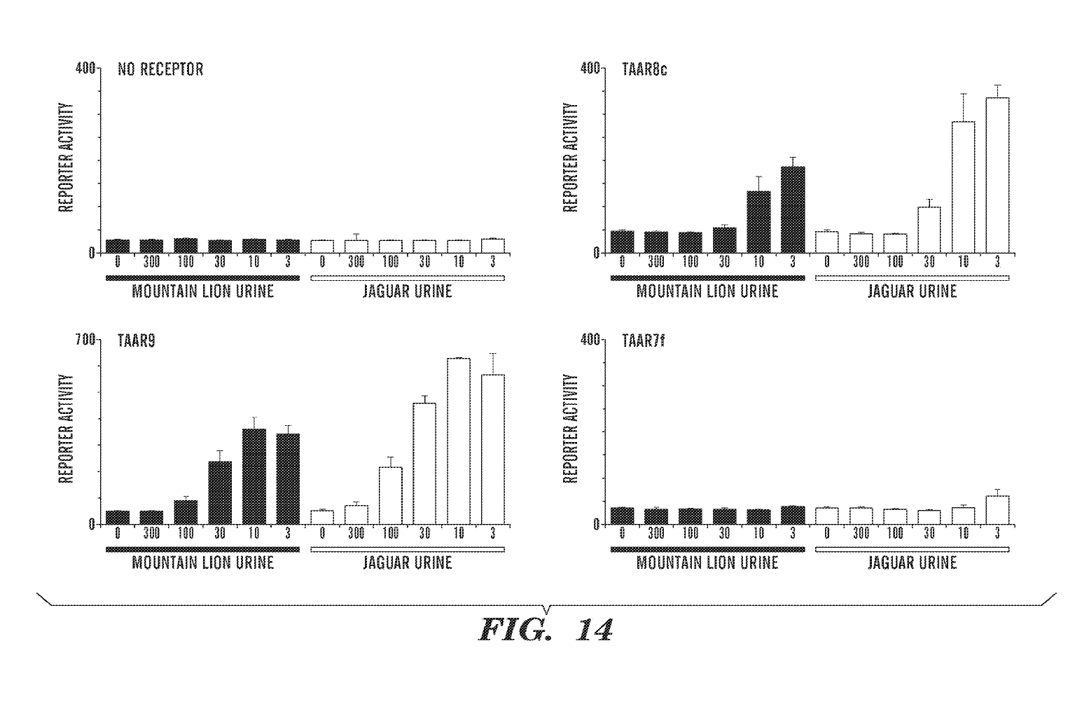

Preparation of urine extracts. For FIG. 14A, urines (850 ml) were basified by addition of sodium hydroxide (150 ml, 1 M), and extracted with dichloromethane (2×480 ml). 20 ml of 1:1 phosphate buffered saline (PBS):dimethylsulfoxide (DMSO) was added to pooled dichloromethane extracts and dichloromethane removed by mild heat (65° C.). Extracts were diluted in cell culture media for TAAR functional assays relative to the original urine volume. For FIG. 14B, mouse, rat, and human urines (425 ml) were basified by addition of sodium hydroxide (75 ml, 1 M), and extracted with dichloromethane (6×800 ml). 20 ml of 0.1% formic acid/water was added to pooled dichloromethane extracts and dichloromethane removed by mild heat (65° C.).

Fractionation and analysis of bobcat urine. Bobcat urine (5 ml) was basified by addition of sodium hydroxide (1 ml, 1 M), and extracted with dichloromethane (3×2 ml). Dichloromethane extracts were pooled and concentrated to ˜500 ml by mild heat (65° C.). Concentrated bobcat extracts were separated by silica gel chromatography using a mobile solvent phase of increasing polarity. Thirty 1 ml fractions were collected using elution mixtures of solvent A (dichloromethane) and solvent B (methanol, 4% NH₄OH), at the following ratios (A:B): 100:0, 95:5, 90:10, 80:20, 70:30, and 50:50. Aliquots (100 ml) of each chromatography fraction were prepared for TAAR4 functional analysis by addition of 1:1 phosphate buffered saline: dimethylsulfoxide (10 ml), removal of organic solvent with mild heat, and dilution in cell culture media (1 ml) for direct testing in the reporter gene assay. Identified fractions with TAAR4 activator were then diluted 1:1 by addition of 5% formic acid/methanol and analyzed by electrospray mass spectrometry using a hybrid linear quadrupole ion trap/FTICR mass spectrometer (LTQ FT, Thermo Fisher Scientific, Bremen, Germany).

Quantitative LC/MS analysis. Urines (350 ml for 1× analysis or 600 ml for 20× analysis) were basified to pH 12.0 by addition of 10 M sodium hydroxide, and extracted with dichloromethane (4×600 ml). Dichloromethane was partially removed by mild heat (55° C.). When sample volumes decreased ˜75%, 0.1% formic acid/water was added to extracts (350 ml for 1× analysis or 30 ml for 20× analysis). The remainder of the dichloromethane was then removed by returning samples to mild heat (55° C.). Extracts or 20× concentrated extracts were analyzed by LC/MS using a Hypercarb column (Thermo Scientific, 4.6×100 mm) on an Agilent 1200 HPLC instrument (Agilent Technologies). Samples were eluted (12 minute run, flow rate 0.7 ml/minute) using a linear gradient (0 to 60%) of solvent A (acetonitrile plus 0.1% formic acid) in solvent B (water plus 0.1% formic acid). The samples were analyzed in tandem by mass spectroscopy on an Agilent 6130 Quadrupole LC/MS system (Agilent Technologies). The number of ion counts with m/z=122 (the mass of ionized 2-phenylethylamine) was graphed over time, with a lower detection limit of 1 mM, and an integrated peak size linearly correlated with concentration up to 40 mM. Specimens indicating >40 mM 2-phenylethylamine were subsequently analyzed following dilution to measure in this linear range. For each sample, a control extraction of urine spiked with 14 mM 2-phenylethylamine was run in parallel to quantify recovery during extraction, inferred by difference measurement, and verify that observed peaks in the test specimen had the same retention time as 2-phenylethylamine. Calculations of 2-phenylethylamine concentration in original specimens were based on the observed recovery rate of 2-phenylethylamine in control extractions (average of 55%). Urine extracts were used because they enabled concentration of 2-phenylethylamine for analysis, and because direct quantification of 2-phenylethylamine in urine, without extraction, resulted in an underestimation of 2-phenylethylamine levels, as assessed in spiked specimens.

Confocal calcium imaging of olfactory sensory neurons in tissue slices. Recordings were performed as described (Spehr M, et al. (2006) Essential role of the main olfactory system in social recognition of major histocompatibility complex peptide ligands. J Neurosci 26(7):1961-1970) with the following modifications. For calcium sensitive dye loading, slices of olfactory epithelium were incubated (30 min, 4° C.) in HEPES solution (in mM: 145 NaCl, 5 KCl, 1 CaCl₂, 1 MgCl₂, 10 HEPES; pH=7.3) containing Fluo-4/AM (2 μM; Molecular Probes). Slices were transferred to a recording chamber (Slice Mini Chamber, Luigs & Neumann, Ratingen, Germany) and visualized using a Leica DM6000CFS confocal fixed stage upright microscope (Leica Microsystems, Mannheim, Germany) equipped with an apochromatic water immersion objective (HC X APO L20x/1.0 W) and infrared-optimized differential interference contrast (DIC) optics. Slices were anchored via stainless steel wires with 0.1 mm lycra threads and continuously superfused with HEPES-buffered solution. Changes in cytosolic calcium were monitored over time at 1.0 Hz frame rate. Stimulus application as well as solution exchange during inter-stimulus intervals was achieved by a custom-made, pressure-driven focal application device consisting of a software-controlled valve bank connected to a 7-in-1 ‘perfusion pencil’. Rhodamine application controlled for uniform flow and even stimulus application throughout the epithelial sensory surface. Offline analysis of time-lapse experiments was performed using LAS-AF software (Leica). All cells in a given field of view were marked as individual regions of interest (ROIs), and the relative fluorescence intensity for each ROI was calculated and processed as a function of time.

Modulation of 2-phenylethylamine levels in lion urine. ‘PEA-depleted lion urine’ was prepared by addition of 90 ml Human MAO-B (BD Biosciences, 5 mg/ml) to 1 ml 10% lion urine/PBS (Specimen 6, FIG. 18) and incubation (24 h, 37° C.). ‘PEA-respiked lion urine’ was derived from ‘PEA-depleted lion urine’ by incubation (2 h, 37° C.) with R-deprenyl hydrochloride (20 mM final concentration) followed by addition of 2-phenylethylamine to 31 mM, the original level in 10% lion urine. Quantitative LC/MS analysis verified reduction of 2-phenylethylamine in ‘PEA-depleted lion urine’ and recovery of 2-phenylethylamine in ‘PEA-respiked lion urine’ (FIG. 18C). All behavior experiments involving ‘PEA-respiked lion urine’ were done immediately following PEA re-addition, since prolonged incubation of ‘PEA-respiked lion urine’ (4 h, 37° C.) resulted in partial degradation of respiked 2-phenylethylamine due to residual MAO-B activity.

Open field behavioral analysis. Rat behavioral responses to odors in the open field were measured as described previously (Fendt M (2006) Exposure to urine of canids and felids, but not of herbivores, induces defensive behavior in laboratory rats. Journal of chemical ecology 32(12):2617-2627) with the following modifications. Adult Sprague-Dawley rats (240-340 g; Janvier, Le Genest St. Isle, France) were placed in the center of a 45 cm×45 cm Plexiglass arena (TSE Systems, Bad Homburg, Germany) equipped with infrared sensors (distance 14 mm, illumination 80-120 lux). The arena contained glass dishes (36 mm) in each corner, with one dish containing test stimuli. Prior to testing, animals were habituated to the arena by introducing them for three consecutive days. Next, test stimuli (see below) were presented to each rat on subsequent days in a pseudorandomized order and pseudorandomized odor corner. Amines were applied as free bases rather than as hydrochloride salts since acidification decreases amine volatility. All tests were performed between 8:00 and 10:00 AM of a normal light cycle (lights on at 5 AM). The arena was cleaned with soapy water between experimental sessions. Location of the rats was automatically recorded using the infrared detectors and analyzed (TSE Systems software). Statistical significance was measured using Wilcoxon Signed Test (**p<0.01; comparison with chance level (25%)).

Three different experiments were performed, each using 12 rats. In the first experiment (FIG. 18B, 18C), each rat was exposed to 1 ml water, 1 ml lion urine (Specimen 1, FIG. 18), 1 ml coyote urine, 5 μl benzylamine, 5 μl 2-phenylethylamine (PEA, free base, catalog #128945). After the experimental sequence, all animals were tested with water controls, to verify the absence of residual effects. In the second experiment (FIG. 16), stimuli included PEA (0, 0.05, 0.5, or 5 μl) in 1 ml water or 1 ml giraffe urine, as well as 1 ml 10% lion urine/water (Specimen 1, FIG. 18) as a control. In the third experiment (FIG. 19C), stimuli included 1 ml water, 1 ml 1% and 10% lion urine/PBS, 1 ml 1% and 10% ‘PEA-depleted lion urine’/PBS, and 1 ml 1 and 10% ‘PEA-respiked lion urine’/PBS. In experiment three, one animal was excluded from final analysis since this animal showed almost no exploratory behavior throughout the whole experiment leading to a presence of more than 90% in one quadrant.

Mouse odor responses in a compartment assay. Individual male mice (8 weeks old) were placed in a test cage (17×28 cm) modified from previous designs (Kobayakawa K, et al. (2007) Innate versus learned odour processing in the mouse olfactory bulb. Nature 450(7169):503-508). Aerosolized odors, dissolved in water or dipropylene glycol (DPG), were delivered through a gas port into a compartment of the arena such that 2/3 of the arena remained odor-free. Animals were subjected to 6 minute trials consisting of 3 minutes of pure air delivery, followed by 3 minutes of odor delivery. The percentage change in odor compartment occupancy during stimulus application was calculated. Animals with less than 10% occupancy of the test compartment prior to odor exposure were excluded. Statistical significance was measured by comparison to wild type water exposures using a Student's t test.

Plasma corticosterone assay. Rats were exposed to aqueous odor-containing solutions (1 ml water, 10% 2-phenylethylamine, 10% benzylamine, or 2% TMT, 30 min, n=16, 20, 8, 16) in a small box (32×20×16 cm), and rapidly decapitated for plasma collection. Corticosterone levels were measured in duplicate using a competitive radioactive binding assay as described previously (Pryce C R, Bettschen D, Bahr N I, & Feldon J (2001) Comparison of the effects of infant handling, isolation, and nonhandling on acoustic startle, prepulse inhibition, locomotion, and HPA activity in the adult rat. Behav Neurosci 115(1):71-83).

### REFERENCES

1. Apfelbach R, Blanchard C D, Blanchard R J, Hayes R A, & McGregor I S (2005) The effects of predator odors in mammalian prey species: a review of field and laboratory studies. Neuroscience and biobehavioral reviews 29(8):1123-1144.
2. Burger B V (2005) Mammalian semiochemicals. Topics in Current Chemistry 240:231-278.
3. Fendt M, Endres T, Lowry C A, Apfelbach R, & McGregor I S (2005) TMT-induced autonomic and behavioral changes and the neural basis of its processing. Neuroscience and biobehavioral reviews 29(8): 1145-1156.
4. Kobayakawa K, et al. (2007) Innate versus learned odour processing in the mouse olfactory bulb. Nature 450(7169):503-508.
5. Papes F, Logan D W, & Stowers L (2010) The vomeronasal organ mediates interspecies defensive behaviors through detection of protein pheromone homologs. Cell 141:692-703.
6. Berton F, Vogel E, & Belzung C (1998) Modulation of mice anxiety in response to cat odor as a consequence of predators diet Physiology & behavior 65(2):247-254.
7. Ben-Shaul Y, Katz L C, Mooney R, & Dulac C (2010) In vivo vomeronasal stimulation reveals sensory encoding of conspecific and allospecific cues by the mouse accessory olfactory bulb. Proceedings of the National Academy of Sciences of the United States of America 107(11):5172-5177.
8. Leypold B G, et al. (2002) Altered sexual and social behaviors in trp2 mutant mice. Proceedings of the National Academy of Sciences of the United States of America 99(9):6376-6381.
9. Stowers L, Holy T E, Meister M, Dulac C, & Koentges G (2002) Loss of sex discrimination and male-male aggression in mice deficient for TRP2. Science (New York, N.Y. 295(5559):1493-1500.
10. Liberles S D & Buck L B (2006) A second class of chemosensory receptors in the olfactory epithelium. Nature 442(7103):645-650.
11. Malnic B, Hirono J, Sato T, & Buck L B (1999) Combinatorial receptor codes for odors. Cell 96(5):713-723.
12. He J, Ma L, Kim S, Nakai J, & Yu C R (2008) Encoding gender and individual information in the mouse vomeronasal organ. Science (New York, N.Y. 320(5875):535-538.
13. Leinders-Zufall T, et al. (2004) MHC class I peptides as chemosensory signals in the vomeronasal organ. Science (New York, N.Y. 306(5698):1033-1037.
14. Leinders-Zufall T, et al. (2000) Uhrasensitive pheromone detection by mammalian vomeronasal neurons. Nature 405(6788):792-796.
15. Spehr M, et al. (2006) Essential role of the main olfactory system in social recognition of major histocompatibility complex peptide ligands. J Neurosci 26(7):1961-1970.
16. Ben-Chaim Y, Cheng M M, & Yau K W (2011) Unitary response of mouse olfactory receptor neurons. Proceedings of the National Academy of Sciences of the United States of America 108(2):822-827.
17. Fendt M (2006) Exposure to urine of canids and felids, but not of herbivores, induces defensive behavior in laboratory rats. Journal of chemical ecology 32(12):2617-2627.
18. Grimsby J, et al. (1997) Increased stress response and beta-phenylethylamine in MAOB-deficient mice. Nat Genet 17(2):206-210.
19. Novotny M, Harvey S, Jemiolo B, & Alberts J (1985) Synthetic pheromones that promote internale aggression in mice. Proceedings of the National Academy of Sciences of the United States of America 82(7):2059-2061.
20. Kaufman S (1999) A model of human phenylalanine metabolism in normal subjects and in phenylketonuric patients. Proceedings of the National Academy of Sciences of the United States of America 96(6):3160-3164.
21. Lindemann L, et al. (2005) Trace amine-associated receptors form structurally and functionally distinct subfamilies of novel G protein-coupled receptors. Genomics 85(3):372-385.
22. Mitchell S C & Smith R L (2001) Trimethylaminuria: the fish malodor syndrome. Drug metabolism and disposition: the biological fate of chemicals 29(4 Pt 2):517-521.
23. Nishimura K, Utsumi K, Yuhara M, Fujitani Y, & Iritani A (1989) Identification of puberty accelerating pheromones in male mouse urine. J Exp Zool 251(3):300-305.
24. Krautwurst D, Yau K W, & Reed R R (1998) Identification of ligands for olfactory receptors by functional expression of a receptor library. Cell 95(7):917-926.
25. Munger, S. D., Leinders-Zufall, T., and Zufall, F. (2009) Subsystem organization of the mammalian sense of smell, Annu Rev Physiol 71, 115-140.
26. Su, C. Y., Menuz, K., and Carlson, J. R. (2009) Olfactory perception: receptors, cells, and circuits, Cell 139, 45-59.
27. Malnic, B., Hirono, J., Sato, T., and Buck, L. B. (1999) Combinatorial receptor codes for odors, Cell 96, 713-723.
28. Mombaerts, P. (2004) Genes and ligands for odorant, vomeronasal and taste receptors, Nat Rev Neurosci 5, 263-278.
29. Reisert, J., and Restrepo, D. (2009) Molecular tuning of odorant receptors and its implication for odor signal processing, Chem Senses 34, 535-545.
30. Keller, A., Zhuang, H., Chi, Q., Vosshall, L. B., and Matsunami, H. (2007) Genetic variation in a human odorant receptor alters odour perception, Nature 449, 468-472.
31. Nara, K., Saraiva, L. R., Ye, X., and Buck, L. B. A large-scale analysis of odor coding in the olfactory epithelium, J Neurosci 31, 9179-9191.
32. Saito, H., Chi, Q., Zhuang, H., Matsunami, H., and Mainland, J. D. (2009) Odor coding by a Mammalian receptor repertoire, Sci Signal 2, ra9.
33. Kato, A., and Touhara, K. (2009) Mammalian olfactory receptors: pharmacology, G protein coupling and desensitization, Cell Mol Life Sci 66, 3743-3753.
34. Katada, S., Hirokawa, T., Oka, Y., Suwa, M., and Touhara, K. (2005) Structural basis for a broad but selective ligand spectrum of a mouse olfactory receptor: mapping the odorant-binding site, J Neurosci 25, 1806-1815.
35. Krautwurst, D., Yau, K. W., and Reed, R. R. (1998) Identification of ligands for olfactory receptors by functional expression of a receptor library, Cell 95, 917-926.
36. Zucchi, R., Chiellini, G., Scanlan, T. S., and Grandy, D. K. (2006) Trace amine-associated receptors and their ligands, Br J Pharmacol 149, 967-978.
37. Lewin, A. H. (2006) Receptors of mammalian trace amines, AAPS J 8, E138-145.
38. Hussain, A., Saraiva, L. R., and Korsching, S. I. (2009) Positive Darwinian selection and the birth of an olfactory receptor clade in teleosts, Proc Natl Acad Sci USA 106, 4313-4318.
39. Shi, L., and Javitch, J. A. (2002) The binding site of aminergic G protein-coupled receptors: the transmembrane segments and second extracellular loop, Annu Rev Pharmacol Toxicol 42, 437-467.
40. Liberles, S. D., and Buck, L. B. (2006) A second class of chemosensory receptors in the olfactory epithelium, Nature 442, 645-650.
41. Borowsky, B., Adham, N., Jones, K. A., Raddatz, R., Artymyshyn, R., Ogozalek, K. L., Durkin, M. M., Lakhlani, P. P., Bonini, J. A., Pathirana, S., Boyle, N., Pu, X., Kouranova, E., Lichtblau, H., Ochoa, F. Y., Branchek, T. A., and Gerald, C. (2001) Trace amines: identification of a family of mammalian G protein-coupled receptors, Proc Natl Acad Sci USA 98, 8966-8971.
42. Ferrero, D. M., Lemon, J. K., Fluegge, D., Pashkovski, S. L., Korzan, W. J., Datta, S. R., Spehr, M., Fendt, M., and Liberles, S. D. Detection and avoidance of a carnivore odor by prey, Proc Natl Acad Sci USA 108, 11235-11240.
43. Ferrero, D. M., and Liberles, S. D. The secret codes of mammalian scents, Wiley Interdiscip Rev Syst Biol Med 2, 23-33.
44. Kobayakawa, K., Kobayakawa, R., Matsumoto, H., Oka, Y., Imai, T., Ikawa, M., Okabe, M., Ikeda, T., Itohara, S., Kikusui, T., Mori, K., and Sakano, H. (2007) Innate versus learned odour processing in the mouse olfactory bulb, Nature 450, 503-508.
45. Franzen, F., and Gross, H. (1965) Tryptamine, N,N-dimethyltryptamine, N,N-dimethyl-5-hydroxytryptamine and 5-methoxytryptamine in human blood and urine, Nature 206, 1052.
46. Sitaram, B. R., Lockett, L., Blackman, G. L., and McLeod, W. R. (1987) Urinary excretion of 5-methoxy-N,N-dimethyltryptamine, N,N-dimethyltryptamine and their N-oxides in the rat, Biochem Pharmacol 36, 2235-2237.
47. Dulac, C., and Torello, A. T. (2003) Molecular detection of pheromone signals in mammals: from genes to behaviour, Nat Rev Neurosci 4, 551-562.
48. Rasmussen, S. G., Choi, H. J., Fung, J. J., Pardon, E., Casarosa, P., Chae, P. S., Devree, B. T., Rosenbaum, D. M., Thian, F. S., Kobilka, T. S., Schnapp, A., Konetzki, I., Sunahara, R. K., Gellman, S. H., Pautsch, A., Steyaert, J., Weis, W. I., and Kobilka, B. K. Structure of a nanobody-stabilized active state of the beta(2) adrenoceptor, Nature 469, 175-180.
49. Rosenbaum, D. M., Rasmussen, S. G., and Kobilka, B. K. (2009) The structure and function of G-protein-coupled receptors, Nature 459, 356-363.
50. Shimamura, T., Shiroishi, M., Weyand, S., Tsujimoto, H., Winter, G., Katritch, V., Abagyan, R., Cherezov, V., Liu, W., Han, G. W., Kobayashi, T., Stevens, R. C., and Iwata, S. Structure of the human histamine H1 receptor complex with doxepin, Nature 475, 65-70.
51. Feinstein, P., Bozza, T., Rodriguez, I., Vassalli, A., and Mombaerts, P. (2004) Axon guidance of mouse olfactory sensory neurons by odorant receptors and the beta2 adrenergic receptor, Cell 117, 833-846.
52. Roth, C., Rastogi, S., Arvestad, L., Dittmar, K., Light, S., Ekman, D., and Liberles, D. A. (2007) Evolution after gene duplication: models, mechanisms, sequences, systems, and organisms, J Exp Zool B Mol Dev Evol 308, 58-73.
53. Katoh, K., Misawa, K., Kuma, K., and Miyata, T. (2002) MAFFT: a novel method for rapid multiple sequence alignment based on fast Fourier transform, Nucleic Acids Res. 30, 3059-3066.
54. Thompson, J. D., Higgins, D. G., and Gibson, T. J. (1994) CLUSTAL W: improving the sensitivity of progressive multiple sequence alignment through sequence weighting, position-specific gap penalties and weight matrix choice, Nucleic Acids Res 22, 4673-4680.
55. Posada, D., and Crandall, K. A. (1998) MODELTEST: testing the model of DNA substitution, Bioinformatics 14, 817-818.
56. Ronquist, F., and Huelsenbeck, J. P. (2003) MrBayes 3: Bayesian phylogenetic inference under mixed models, Bioinformatics 19, 1572-1574.
57. Abagyan, R. A., and Batalov, S. (1997) Do aligned sequences share the same fold?, J Mol Biol 273, 355-368.
58. Cardozo, T., Totrov, M., and Abagyan, R. (1995) Homology modeling by the ICM method, Proteins 23, 403-414.
59. Emsley, P., Lohkamp, B., Scott, W. G., and Cowtan, K. Features and development of Coot, Acta Crystallogr D Biol Crystallogr 66, 486-501.

To the extent not already indicated, it will be understood by those of ordinary skill in the art that any one of the various embodiments herein described and illustrated can be further modified to incorporate features shown in any of the other embodiments disclosed herein.

All patents and other publications identified are expressly incorporated herein by reference for the purpose of describing and disclosing, for example, the methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

What is claimed is:

1. A method for controlling a rodent, comprising contacting a rodent with a composition comprising 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, a derivative, or an analogue thereof.

2. The method of claim 1, wherein controlling the rodent comprises repelling the rodent.

3. The method of claim 1, wherein the method comprises an area-wide application comprising 2-phenylethylamine, N,N-dimethylcyclohexylamine, 5-methoxy-N,N-dimethyltryptamine, N,N-dimethylphenylethylamine, or a combination thereof.

4. The method of claim 1, wherein 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine or a combination thereof is embedded within a material.

5. The method of claim 4, wherein the material is a siding, wall studs, or beam.

6. The method of claim 1, wherein 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, or a combination thereof is applied to plants, animals or objects within an environment that comes into contact with the rodent.

7. The method of claim 1, wherein 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, or a combination thereof is in a delivery device which allows for releasing said compound in the air.

8. A delivery device comprising 2-phenylethylamine, N,N-dimethylcyclohexylamine, 5-methoxy-N,N-dimethyltryptamine, N,N-dimethylphenylethylamine, isoamylamine, N,N-dimethyloctylamine, N,N-dimethylbutylamine, 1-methylpiperidine, or a combination thereof, wherein the delivery device allows for release on the compound in the air.

9. A method for controlling a rodent, comprising contacting a rodent with a composition, wherein the composition comprises a ligand of an olfactory trace amine associated receptor (TAAR).
